(19) United States
(12) Patent Application Publication
(10) Pub. No.: US 2024/0089776 A1
(43) Pub. Date: Mar. 14, 2024

(54) USER EQUIPMENT LOCALIZATION IN CENTRALIZED OR CLOUD RADIO ACCESS NETWORK

(71) Applicant: CommScope Technologies LLC, Hickory, NC (US)

(72) Inventors: Naveen Shanmugaraju, Bangalore (IN); Irfaan Ahamed Salahuddeen, Acton, MA (US)

(73) Assignee: CommScope Technologies LLC, Hickory, NC (US)

(21) Appl. No.: 18/463,850

(22) Filed: Sep. 8, 2023

Related U.S. Application Data
(60) Provisional application No. 63/405,193, filed on Sep. 9, 2022.

(51) Int. Cl. H04W 24/10; H04B 17/318; H04W 72/54

(52) U.S. Cl. CPC H04W 24/10; H04B 17/318; H04W 72/54

(57) ABSTRACT

The present disclosure describes techniques of user equipment localization in centralized or cloud radio access networks (C-RANs). In the UE localization techniques of the present disclosure, a base station (gNB) configures a plurality of radio units (RUs) serving a cell to transmit one or more downlink signals using various time and/or frequency resources to user equipment (UEs) of the cell. The UEs use the one or more downlink signals to measure quality of downlink channels between the UEs and the plurality of RUs and reports the measured qualities in uplink using one or more CSI reports. The gNB then selects one or more RUs from the plurality of RUs for each UE based on the received CSI reports. Finally, the gNB transmits downlink data towards the UEs and receives uplink data from the UEs using their respective RUs.

### CROSS-REFERENCE TO RELATED APPLICATIONS

This application claims the benefit of U.S. Provisional Patent Application Ser. No. 63/405,193, filed on Sep. 9, 2022, which is hereby incorporated herein by reference in its entirety.

### TECHNICAL FIELD

The present disclosure in general relates to wireless communication systems. More particularly, but not exclusively, the present disclosure relates to methods and systems for localizing user equipment in a centralized or cloud radio access network (C-RAN).

### BACKGROUND

The term Radio Access Network (RAN) refers to a part of a mobile communication network that connects wireless devices or user equipment (UE) to a network infrastructure through wireless radio channels. RANs have evolved significantly since the origin of the mobile communication networks. Different generations of mobile communication networks use different types of RANs for implementing base station functionalities. A cloud or centralized radio access network (C-RAN) is one way to implement the base station functionalities in modern mobile communication networks for providing wireless services to UEs.

Typically, a C-RAN implements the base station functionalities using one or more centralized baseband units (BBUs) which are physically separated and communicatively coupled with a plurality of radio units (RUs). The C-RAN may be used to implement a plurality of cells and for each cell implemented by the C-RAN, one or more BBUs may be communicatively coupled with a plurality of RUs over a fronthaul network for serving UEs of the cell. Each UE of the cell may be served by one or more RUs of the plurality of RUs. In such a network, there arises a need to localize the UEs with respect to the plurality of RUs serving the cell. In the context of the present disclosure, localization of a UE may be defined as selection/identification which of the plurality of RUs should be used for serving the UE.

The information disclosed in this background section is only for enhancement of understanding of the general background of the disclosure and should not be taken as an acknowledgement or any form of suggestion that this information forms the prior art already known to a person skilled in the art.

### SUMMARY

According to an aspect of the present disclosure, methods, systems, and computer readable media are provided for localizing user equipment in a centralized or cloud radio access network (C-RAN).

One non-limiting embodiment of the present disclosure is directed to a method performed using a system. The system comprises at least one baseband unit to perform at least some baseband processing and a plurality of radio units to wirelessly communicate with a plurality of user equipment via a respective set of one or more antennas. The at least one baseband unit and the plurality of radio units are communicatively coupled with each other. The method comprises grouping the plurality of radio units into one or more groups, each group comprising at least one radio unit. For each group, the method comprises configuring each radio unit of the group to transmit a different downlink signal to a user equipment at a unique time instance within a predefined time interval. The transmissions of the different downlink signals for one group are repeated in a same sequential manner for another group at time instances distinct from the unique time instances, and a time duration between two consecutive downlink signal transmissions within a group and across the one or more groups is the same. For each group, the method further comprises receiving a measurement report comprising signal strength measurements of the different downlink signals at the end of the predefined time interval. The method further comprises selecting one or more radio units from the plurality of radio units for serving the user equipment based on the received measurement reports.

Another non-limiting embodiment of the present disclosure is directed to a method performed using a system. The system comprises at least one baseband unit to perform at least some baseband processing and a plurality of radio units to wirelessly communicate with a plurality of user equipment via a respective set of one or more antennas. The at least one baseband unit and the plurality of radio units are communicatively coupled with each other. The method comprises partitioning available downlink bandwidth into a plurality of sub-bands and grouping the plurality of radio units into one or more groups. Each group comprises at least one radio unit, and a number of the at least one radio unit in each group is less than or equal to a number of the plurality of sub-bands. At a first time instance and for each group, the method comprises configuring each radio unit of the group to transmit a same downlink signal to a user equipment in a unique sub-band of the plurality of sub-bands. A downlink signal transmitted from at least one radio unit of one group is different from a downlink signal transmitted from at least one radio unit of another group. The method further comprises receiving a measurement report comprising sub-band level signal strength measurements of the downlink signal transmissions from the plurality of radio units after the first-time instance and selecting one or more radio units from the plurality of radio units for serving the user equipment based on the received measurement report.

Another non-limiting embodiment of the present disclosure is directed to a method performed using a system. The system comprises at least one baseband unit to perform at least some baseband processing and a plurality of radio units to wirelessly communicate with a plurality of user equipment via a respective set of one or more antennas. The at least one baseband unit and the plurality of radio units are communicatively coupled with each other. The method comprises partitioning available downlink bandwidth into a plurality of sub-bands and grouping the plurality of radio units into at least one group. Each group comprises at least one radio unit, and a number of the at least one radio unit in each group is less than or equal to a number of the plurality of sub-bands. For each group, the method comprises configuring each radio unit of the group to transmit a same downlink signal to a user equipment in a unique sub-band of the plurality of sub-bands. All radio units of the group transmit the same downlink signal at a particular time instance, and the transmissions of the same downlink signal for one group are repeated for another group at a time instance which is distinct from the particular time instance. For each group, the method further comprises receiving a measurement report comprising sub-band level signal strength measurements of the downlink signal transmissions from the at least one radio unit of the group after the particular time instance. The method further comprises selecting one or more radio units from the plurality of radio units for serving the user equipment based on the received measurement reports.

Another non-limiting embodiment of the present disclosure is directed to a method performed using a system. The system comprises at least one baseband unit to perform at least some baseband processing and a plurality of radio units to wirelessly communicate with a plurality of user equipment via a respective set of one or more antennas. The at least one baseband unit and the plurality of radio units are communicatively coupled with each other. The method comprises grouping the plurality of radio units into one or more groups, each group comprising at least one radio unit. For each group, the method comprises configuring each radio unit of the group to transmit a different downlink signal to a user equipment at a unique time instance within a predefined time interval. The transmissions of the different downlink signals for one group are repeated in a same sequential manner for another group at time instances distinct from the unique time instances. A time duration between two consecutive downlink signal transmissions within each of the one or more groups is the same. For each group, the method further comprises receiving a measurement report comprising signal strength measurements of the different downlink signals after the predefined time interval. The method further comprises selecting one or more radio units from the plurality of radio units for serving the user equipment based on the received measurement reports.

Another non-limiting embodiment of the present disclosure is directed to a method performed using a system. The system comprises at least one baseband unit to perform at least some baseband processing and a plurality of radio units to wirelessly communicate with a plurality of user equipment via a respective set of one or more antennas. The at least one baseband unit and the plurality of radio units are communicatively coupled with each other. The method comprises grouping the plurality of radio units into at least one group, where each group comprises at least one radio unit. For each group, the method comprises configuring each radio unit of the group to transmit a same downlink signal to a user equipment at a same time instance, wherein a downlink signal transmitted from one group of radio units at a time instance is different from a downlink signal transmitted from another group of radio units at a different time instance. The method further comprises receiving a measurement report comprising signal strength measurements of the downlink signal transmissions from each of the one or more groups and identifying at least one group from the one or more groups for serving the user equipment based on the received measurement report.

Another non-limiting embodiment of the present disclosure is directed to a system comprising at least one baseband unit to perform at least some baseband processing and a plurality of radio units to wirelessly communicate with a plurality of user equipment via a respective set of one or more antennas. The at least one baseband unit and the plurality of radio units are communicatively coupled with each other. The system is configured to group the plurality of radio units into one or more groups, each group comprising at least one radio unit. For each group, the system is configured to configure each radio unit of the group to transmit a different downlink signal to a user equipment at a unique time instance within a predefined time interval. The transmissions of the different downlink signals for one group are repeated in a same sequential manner for another group at time instances distinct from the unique time instances, and where a time duration between two consecutive downlink signal transmissions within a group and across the one or more groups is the same. For each group, the system is further configured to receive a measurement report comprising signal strength measurements of the different downlink signals at the end of the predefined time interval. The system is further configured to select one or more radio units from the plurality of radio units for serving the user equipment based on the received measurement reports.

Another non-limiting embodiment of the present disclosure is directed to a system comprising at least one baseband unit to perform at least some baseband processing and a plurality of radio units to wirelessly communicate with a plurality of user equipment via a respective set of one or more antennas. The at least one baseband unit and the plurality of radio units are communicatively coupled with each other. The system is configured to partition available downlink bandwidth into a plurality of sub-bands and grouping the plurality of radio units into one or more groups. Each group comprises at least one radio unit, and a number of the at least one radio unit in each group is less than or equal to a number of the plurality of sub-bands. At a first time instance and for each group, the system is configured to configure each radio unit of the group to transmit a same downlink signal to a user equipment in a unique sub-band of the plurality of sub-bands. A downlink signal transmitted from at least one radio unit of one group is different from a downlink signal transmitted from at least one radio unit of another group. The system is further configured to receive a measurement report comprising sub-band level signal strength measurements of the downlink signal transmissions from the plurality of radio units after the first-time instance and select one or more radio units from the plurality of radio units for serving the user equipment based on the received measurement report.

Another non-limiting embodiment of the present disclosure is directed to a system comprising at least one baseband unit to perform at least some baseband processing and a plurality of radio units to wirelessly communicate with a plurality of user equipment via a respective set of one or more antennas. The at least one baseband unit and the plurality of radio units are communicatively coupled with each other. The system is configured to partition available downlink bandwidth into a plurality of sub-bands and group the plurality of radio units into at least one group, each group comprising at least one radio unit and a number of the at least one radio unit in each group being less than or equal to a number of the plurality of sub-bands. For each group, the system is configured to configure each radio unit of the group to transmit a same downlink signal to a user equipment in a unique sub-band of the plurality of sub-bands. All radio units of the group transmit the same downlink signal at a particular time instance, and the transmissions of the same downlink signal for one group are repeated for another group at a time instance which is distinct from the particular time instance. For each group, the system is further configured to receive a measurement report comprising sub-band level signal strength measurements of the downlink signal transmissions from the at least one radio unit of the group after the particular time instance. The system is further configured to select one or more radio units from the plurality of radio units for serving the user equipment based on the received measurement reports.

Another non-limiting embodiment of the present disclosure is directed to a system comprising at least one baseband unit to perform at least some baseband processing and a plurality of radio units to wirelessly communicate with a plurality of user equipment via a respective set of one or more antennas. The at least one baseband unit and the plurality of radio units are communicatively coupled with each other. The system is configured to group the plurality of radio units into one or more groups, each group comprising at least one radio unit. For each group, the system is configured to configure each radio unit of the group to transmit a different downlink signal to a user equipment at a unique time instance within a predefined time interval. The transmissions of the different downlink signals for one group are repeated in a same sequential manner for another group at time instances distinct from the unique time instances, and where a time duration between two consecutive downlink signal transmissions within each of the one or more groups is the same. For each group, the system is further configured to receive a measurement report comprising signal strength measurements of the different downlink signals after the predefined time interval. The system is further configured to select one or more radio units from the plurality of radio units for serving the user equipment based on the received measurement reports.

Another non-limiting embodiment of the present disclosure is directed to a system comprising at least one baseband unit to perform at least some baseband processing and a plurality of radio units to wirelessly communicate with a plurality of user equipment via a respective set of one or more antennas. The at least one baseband unit and the plurality of radio units are communicatively coupled with each other. The system is configured to group the plurality of radio units into at least one group, wherein each group comprises at least one radio unit. For each group, the system is configured to configure each radio unit of the group to transmit a same downlink signal to a user equipment at a same time instance, where a downlink signal transmitted from one group of radio units at a time instance is different from a downlink signal transmitted from another group of radio units at a different time instance. The system is further configured to receive a measurement report comprising signal strength measurements of the downlink signal transmissions from each of the one or more groups and identify at least one group from the one or more groups for serving the user equipment based on the received measurement report.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Further aspects and advantages of the present disclosure will be readily understood from the following detailed description with reference to the accompanying drawings. Reference numerals have been used to refer to identical or functionally similar elements. The figures together with a detailed description below, are incorporated in and form part of the specification, and serve to further illustrate the embodiments and explain various principles and advantages, in accordance with the present disclosure wherein:

FIG. 1 shows an exemplary illustration of a radio access network (RAN) communication system 100 in which the user equipment (UE) localization techniques of the present disclosure may be used, in accordance with some embodiments of the present disclosure.

FIG. 2 shows an exemplary downlink signal transmission pattern 200 for UE localization in an exemplary RAN deployment, in accordance with some embodiments of the present disclosure.

FIG. 3 shows another downlink signal transmission pattern 300 for UE localization in an exemplary RAN deployment, in accordance with some embodiments of the present disclosure.

FIG. 4 shows yet another downlink signal transmission pattern 400 for UE localization in an exemplary RAN deployment, in accordance with some embodiments of the present disclosure.

FIG. 5 shows yet another downlink signal transmission pattern 500 for UE localization in an exemplary RAN deployment, in accordance with some embodiments of the present disclosure.

FIG. 6 shows yet another downlink signal transmission pattern 600 for UE localization in an exemplary RAN deployment, in accordance with some embodiments of the present disclosure.

FIG. 7 shows yet another downlink signal transmission pattern 700 for UE localization in an exemplary RAN deployment, in accordance with some embodiments of the present disclosure.

FIG. 8 shows a further downlink signal transmission pattern 800 for UE localization in an exemplary RAN deployment, in accordance with some embodiments of the present disclosure.

FIG. 9 shows a further downlink signal transmission pattern 900 for UE localization in an exemplary RAN deployment, in accordance with some embodiments of the present disclosure.

FIG. 10 shows yet another downlink signal transmission pattern 1000 for UE localization in an exemplary RAN deployment, in accordance with some embodiments of the present disclosure.

FIG. 11 shows a high-level block diagram of an apparatus 1100 which may implement the UE localization techniques consistent with the present disclosure, in accordance with some embodiments of the present disclosure.

FIG. 12 shows a flowchart of an exemplary method 1200 for UE localization, in accordance with some embodiments of the present disclosure.

FIG. 13 shows a flowchart of another exemplary method 1300 for UE localization, in accordance with some embodiments of the present disclosure.

FIG. 14 shows a flowchart of yet another exemplary method 1400 for UE localization, in accordance with some embodiments of the present disclosure.

FIG. 15 shows a flowchart of yet another exemplary method 1500 for UE localization, in accordance with some embodiments of the present disclosure.

FIG. 16 shows a flowchart of yet another exemplary method 1600 for UE localization, in accordance with some embodiments of the present disclosure.

It should be appreciated by those skilled in the art that any block diagrams herein represent conceptual views of the illustrative systems embodying the principles of the present disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present disclosure described herein as “exemplary” is not necessarily to be construed as preferred or advantageous over other embodiments.

While the disclosure is susceptible to various modifications and alternative forms, specific embodiments thereof have been shown by way of examples in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus preceded by “comprises . . . a” does not, without more constraints, preclude the existence of other elements or additional elements in the system.

In the present disclosure, the terms like “RAN communication system” “communication system” may be used interchangeably throughout the description. The terms like “centralized RAN” and “cloud RAN” may be used interchangeably throughout the description. The terms like “CSI report” and “measurement report” may be used interchangeably throughout the description.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

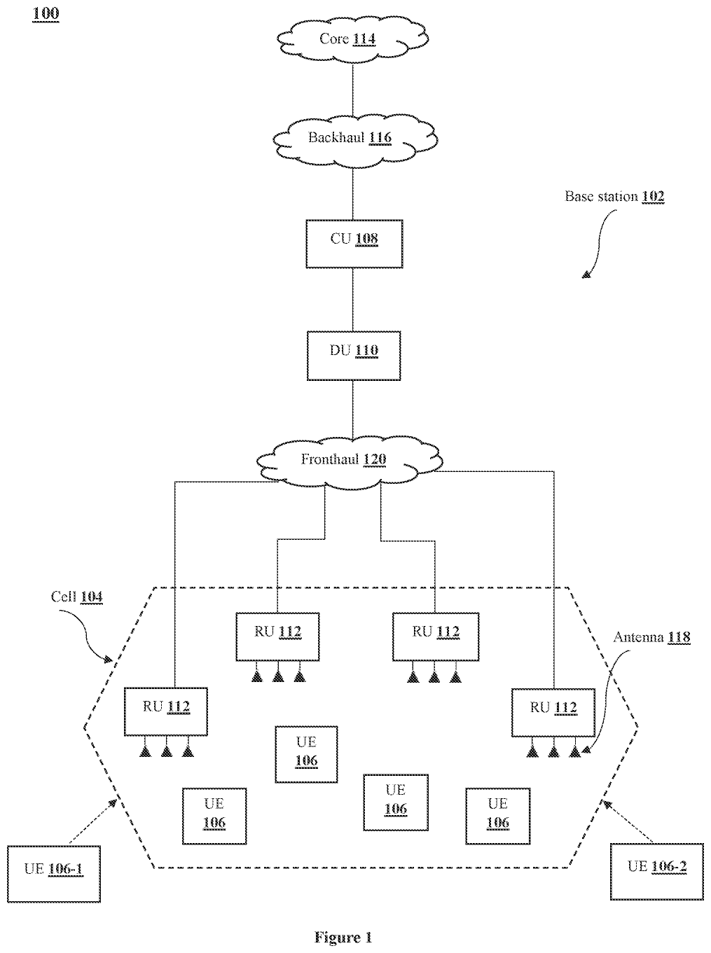

Referring now to FIG. 1 which shows a block diagram illustrating an exemplary radio access network (RAN) communication system 100 in which the techniques of the present disclosure may be implemented. The RAN communication system 100 may comprise a base station entity 102 which may serve a cell 104. The base station entity 102 may also be referred to as a “base station” or “base station system” (and, which in the context of a fourth generation (4G) Long Term Evolution (LTE) system, may also be referred to as an “evolved NodeB”, “eNodeB”, or “eNB” and, in the context of a fifth generation (5G) New Radio (NR) system, may also be referred to as a “gNodeB” or “gNB”).

The cell 104 may have at least one UE 106 associated with it. The base station 102 may be configured to provide wireless services to the at least one UE 106 served by the associated cell 104. The at least one UE 106 may be any mobile or non-mobile computing device including, but not limited to, a phone (e.g., a cellular phone or smart phone), a pager, a laptop computer, a desktop computer, a wireless handset, a portable communication device, a portable computing device (e.g., a personal data assistant), an entertainment device (e.g., a music or video device, or a satellite radio), a global positioning system device, or any other suitable computing device including a wired or wireless communications interface. In some embodiments of the present disclosure, the at least one UE 106 may be Internet-of-Things (IoT)-enabled device including, but not limited to, sensors, actuators, vehicles, and drones and gateways therefor and can be embedded in other devices (for example, to implement so-called “smart” devices that can be remotely monitored or controlled using one or more wireless-connectivity enabled applications) and/or can be attached to or otherwise associated with devices that do not natively include the functionality implemented by the associated IoT devices (for example, in a so-called “retro-fit” application where an otherwise “dumb” device is made “smart” by attaching or otherwise associating the IoT device with the dumb device).

Unless explicitly stated to the contrary, references to Layer 1, Layer 2, Layer 3, and other or equivalent layers (such as the Physical Layer or the Media Access Control Layer) refer to layers of the particular wireless interface (for example, 4G LTE or 5G NR) used for wirelessly communicating with the at least one UE 106. Furthermore, it is also to be understood that the techniques of the present disclosure can be used in both standalone and non-standalone modes (or other modes developed in the future), and the following description is not intended to be limited to any particular mode. Moreover, although some embodiments are described here as being implemented for use with 5G wireless systems and interfaces, the following description is not intended to be limited to any particular wireless system or interface.

In the exemplary embodiment of FIG. 1, the RAN communication system 100 may be implemented using a centralized or cloud RAN (C-RAN) architecture in which the base station 102 is implemented as a 5G NR gNB 102. In this embodiment, the gNB 102 may be partitioned into a central unit (CU) 108, a distributed unit (DU) 110, and one or more radio units (RUs) 112. In such a configuration, the CU 108 may implement Layer 3 and non-time critical Layer 2 functions for the gNB 102. In this embodiment the CU 108 and the DU 110 are designed to run on or in “cloud” such that they can horizontally and vertically scale computing resources based on traffic demand.

In the embodiment of FIG. 1, the CU 108 may be further partitioned into a control-plane entity (CU-CP) and one or more user-plane entities (CU-UP) (not shown in FIG. 1) that may handle control-plane and user-plane processing of the CU 108, respectively. Also, in such a configuration, the DU 110 may be configured to implement time critical Layer 2 functions and at least some of the Layer 1 functions for the gNB 102. In such configuration, each RU 112 may be configured to implement the Radio Frequency (RF) interface, as well as physical layer functions for the gNB 102 that are not implemented in the DU 110. Also, each RU 112 may include or may be coupled to a respective set of one or more antennas 118 via which downlink RF signals are radiated to the UEs 106 and via which uplink RF signals transmitted by the UEs 106 are received.

In one implementation (as shown in FIG. 1), each RU 112 may be remotely located from the DU 110 serving it, e.g., the RUs 112 may be deployed at a cell site while the DU 110 may be located at a centralized location far from the RUs 112. Also, in such an implementation, at least one of the RUs 112 may be remotely located from at least one other RU 112 serving the associated cell 104. In another implementation, at least some of the RUs 112 may be co-located with each other, where the respective sets of antennas 118 associated with the RUs 112 are directed to transmit and receive signals from different areas.

Each RU 112 may be communicatively coupled to the DU 110 serving it via a fronthaul network 120. The fronthaul network 120 may be implemented using a switched Ethernet network, in that case each RU 112 and the DU 110 may include one or more Ethernet network interfaces to couple each RU 112 and the DU 110 to the fronthaul network 120 in order to facilitate communications between the DU 110 and the RUs 112. In one implementation, the Ethernet network interfaces may be used for communication between the DU 110 and the RUs 112 over the fronthaul network 120.

In such an example, the CU 108 may be configured to communicate with a core network 114 of an associated wireless operator using an appropriate backhaul network 116 (typically, a public wide area network such as the Internet). In one non-limiting embodiment of the present disclosure, the core network 114 may be a 5G core network in a standalone mode of deployment. In another non-limiting embodiment, the core network 114 may be a long-term evolution evolved packet core (LTE EPC) network in a non-standalone mode of deployment where at least some services are provided using previous generation infrastructure (e.g., using existing LTE Evolved Packet Core (EPC)). The present disclosure is applicable for standalone and/or non-standalone modes of deployments or other modes of deployments which may be developed in the future.

The RAN communication system 100 may be implemented in accordance with one or more public standards and specifications. For example, the RAN communication system 100 may be implemented using a RAN architecture and/or RAN fronthaul interfaces defined by the O-RAN Alliance in order to provide 4G LTE and/or 5G wireless service. (“O-RAN” stands for Open Radio Access Network). In such an implementation of RAN communication system 100, the DU 110 and RUs 112 may be implemented as O-RAN distributed units and O-RAN remote/radio units, respectively, in accordance with the O-RAN specifications. However, the present disclosure is not limited thereto and, in general, the RAN communication system 100 may be implemented in other ways as well.

Although FIG. 1 (and the description set forth below more generally) is described in the context of a 5G architecture in which the base station 102 is partitioned into a CU 108, a DU 110, and at least one RU 112 and some physical-layer processing is performed in the DU 110 with the remaining physical-layer processing being performed in the RUs 112, it is to be understood that the techniques described here may be used with other wireless interfaces (for example, 4G LTE) and with other ways of implementing a base station entity (for example, using a conventional baseband band unit (BBU)/remote radio head (RRH) architecture). Accordingly, references to a CU, DU, or RU in this description and associated figures may also be considered to refer more generally to any entity (including, for example, any “base station” or “RAN” entity) implementing any of the functions or features described here as being implemented by a CU, DU, or RU.

Each CU 108, DU 110, RU 112 and any of the specific features described herein may be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.).

Moreover, each CU 108, DU 110, RU 112 may be implemented as a physical network function (PNF) (for example, using dedicated physical programmable devices and other circuitry) and/or a virtual network function (VNF) (for example, using one or more general purpose servers (possibly with hardware acceleration) in a scalable cloud environment and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a “containerized network function” (CNF).

For example, in the exemplary embodiment shown in FIG. 1, each RU 112 may be implemented as a PNF and may be deployed in or near a physical location where radio coverage is to be provided and the CU 108 and the DU 110 may be implemented using a respective set of one or more VNFs deployed in a distributed manner within one or more clouds (for example, within an “edge” cloud or “central” cloud). However, the present disclosure is not limited thereto, and each of CU 108, DU 110, RU 112, and any of the specific features described here as being implemented thereby, may be implemented in other ways.

In the exemplary embodiment of FIG. 1, for the sake of simplicity, it has been shown that the RAN communication system 100 comprises only one base station (gNB) 102, one CU 108, one DU 110, and one cell 104. However, the present disclosure is not limited thereto and in general the RAN communication system 100 may comprise more than one base station (gNB) 102 connected with each other via an Xn interface. Each base station 102 may comprise more than one CU 108, more than one DU 110, more than one RU 112 serving more than one cell 104. In such configuration, the gNB 102 may elastically scale CUs 108 and/or DUs 110 based on a traffic load i.e., when the traffic load is higher, the gNB 102 may add more CUs and/or DUs.

In the exemplary embodiment described in connection with FIG. 1, each RU of the plurality of RUs 112 serving the cell 104 may include or may be coupled to a respective set of one or more antennas 118 via which downlink data may be transmitted from the gNB 102 to the UEs 106 of the cell 104 and via which uplink data from the UEs 106 may be received by the gNB 102. The gNB 102 may be configured to serve each UE of the cell 104 using a set of one or more RUs identified/selected from the plurality of RUs 112. Said differently, the gNB 102 may transmit data to a particular UE of the cell 104 (in the downlink) and may receive data from the particular UE (in the uplink) using one or more specific RUs selected from the plurality of RUs 112. Such selection of the one or more RUs for providing wireless services to the particular UE may be named as “user equipment localization”.

In the present disclosure, the term ‘user equipment localization’ or ‘UE localization’ is used within the context of its broadest definition. The term ‘UE localization’ may refer to identifying one or more suitable radio units for serving a particular UE 106-1 (i.e., for transmitting downlink data to the particular UE 106-1 and receiving uplink data from the particular UE 106-1). In the present disclosure, the techniques of ‘UE localization’ have been explained with the help of the particular UE 106-1 which is entering the cell 104. However, the techniques of UE localization of the present disclosure are equally applicable for any UE which is entering the cell 104 or which is already present inside the cell 104.

The gNB 102 may be configured to identify the one or more RUs for serving the particular UE 106-1 based on one or more signal strength measurements received from the particular UE 106-1 as a part of Channel State Information (CSI) reporting. The one or more signal strength measurements may include any of: pathloss measurements between the particular UE 106-1 and the plurality of RUs 112 of the cell 104, Reference Signal Received Power (RSRP) measurements between the particular UE 106-1 and the plurality of RUs 112 of the cell 104, Signal-to-Interference-plus-Noise Ratio (SINR), Received Signal Strength Indicator (RSSI), Signal-to-noise ratio (SNR), but not limited thereto.

In one implementation, the gNB 102 may perform the UE localization based on uplink reference signals e.g., Sounding Reference Signal (SRS). In such implementation, the gNB 102 may send appropriate messages to the UEs 106 via a Physical Downlink Control Channel (PDCCH) for configuring each of the UEs 106 to make one or more SRS transmissions. The UEs 106 (including the UE 106-1) may then make one or more SRS transmissions via the RUs 112. The gNB 102, upon detecting the SRS transmissions, may measure a respective received signal strength of each of the one or more SRS transmissions received from the UE 106-1 via the RUs 112. The gNB 102 may select one or more RUs from the plurality of RUs 112 for serving the UE 106-1 based on the received signal strength measurements.

However, such mechanisms of UE localization (i.e., UE localization based on uplink reference signals) may not be suitable for all deployment scenarios. For instance, in a C-RAN communication system having downlink only carrier aggregation and non-collocated RUs, the uplink based UE localization mechanisms may not be applied directly for Secondary Component Carriers (SCCs) because the SCCs generally do not have an uplink. Also, in such systems, since the RUs are non-collocated, Primary Component Carriers (PCCs) may not be utilized for UE localization. Hence, it becomes difficult to perform the UE localization based on uplink reference signals in such RAN deployments. Thus, there exists a need for UE localization techniques which are suitable for all RAN deployments (particularly for RAN deployments where UE localization based on uplink reference signals may not be suitable).

To overcome these and other problems, the present disclosure describes various techniques which use downlink signals for UE localization. The downlink signals may be used by the UEs 106 for measuring quality of downlink (DL) channels and report the measured quality in the uplink (UL) using Channel State Information (CSI) reports or measurement reports. In one non-limiting embodiment, the downlink signals used for UE localization may comprise: Channel State Information Reference Signals (CSI-RSs) and Synchronization Signal Blocks (SSBs).

In 5G New Radio (NR), CSI-RSs are transmitted in the DL from the gNB 102 to the UEs 106. The UEs 106 may use the CSI-RSs to measure quality of the DL channels between the UEs 106 and the plurality of RUs 112 and report the measured quality in the UL using CSI reports transmitted on Physical Uplink Shared Channel (PUSCH)/Physical Uplink Control Channel (PUCCH). In 5G NR, SSBs are generally used for initial network access. The gNB 102 periodically transmits SSBs in the form of SSB burst. A SSB burst comprises a set of SSBs, each SSB being transmitted on a different beam in a time-division multiplexing manner. In addition to initial network access, the UEs 106 may use the SSBs to measure quality of the DL channels between the UEs 106 and the plurality of RUs 112 and report the measured quality in the UL using CSI reports.

The forthcoming paragraphs now describe various techniques of UE localization, in accordance with some embodiments of the present disclosure.

Broadly, in the UE localization techniques of the present disclosure, the gNB 102 may configure the plurality of RUs 112 of the cell 104 to transmit one or more signals in downlink direction using various time and/or frequency resources (i.e., in time division and/or frequency division manner) to the UEs 106. The gNB 102 may instruct the UEs (e.g., UE 106-1) to report signal strength measurements of the one or more downlink signal transmissions received from the plurality of RUs 112. The UE 106-1 may use the one or more downlink signals to measure quality of the DL channels between the UE 106-1 and the plurality of RUs 112 and report the measured quality in the UL using one or more CSI reports. The gNB 102 may receive the one or more CSI reports comprising signal strength measurements corresponding to the one or more downlink signal transmissions from the plurality of RUs 112. The gNB 102 may then select one or more RUs from the plurality of RUs 112 for serving the UE 106-1 based on the received CSI reports. The gNB 102 may use the selected one or more RUs to transmit downlink data towards the UE 106-1 and receive uplink data from the UE 106-1.

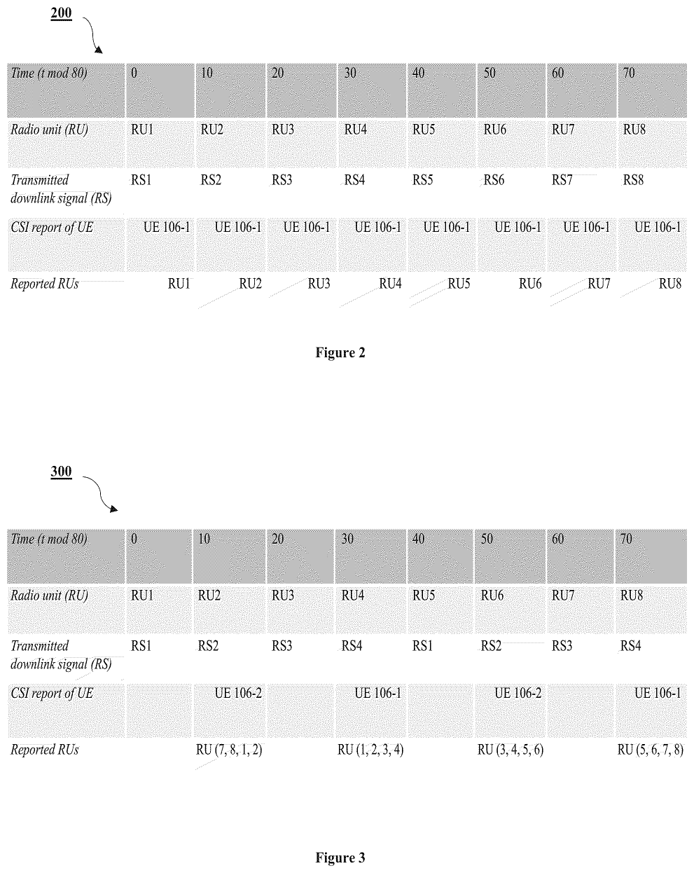

The detailed techniques of UE localization based on downlink signal transmissions (CSI-RS and/or SSB) are now described in connection with FIGS. 2-10. It may be noted that for each of the different RAN deployments (as discussed in connection with FIGS. 2-10), the gNB 102 may store a list comprising mappings among RUs and downlink signal(s) transmitted at various time instances and/or in various sub-bands i.e., the gNB 102 is aware as which RU transmits which downlink signal at a particular time instance and/or in a particular sub-band. Additionally, for each of the different RAN deployments (as discussed in connection with FIGS. 2-10), the list may further comprise mappings among CSI reporting(s) and RUs based on timings of CSI reports i.e., based on a timing of a CSI report, gNB 102 can easily determine the RUs corresponding to the received CSI report.

In one non-limiting RAN deployment for UE localization, the gNB 102 may associate a unique downlink signal (e.g., CSI-RS) with each of the plurality of RUs 112. The gNB 102 may configure each RU to transmit a corresponding unique downlink signal at a unique time instance towards the UEs 106 (in downlink direction) within a predefined time duration (as shown in FIG. 2). The gNB 102 may configure the RUs 112 such that during the predefined time duration, each RU makes only one downlink signal transmission and a time duration between two consecutive downlink signal transmissions within the predefined time duration is the same. In such a RAN deployment, a total number of unique downlink signals that are transmitted in downlink direction within the predefined time duration is the same as the total number of the plurality of RUs 112 serving the cell 104. This RAN deployment may be explained in detail with the help of FIG. 2.

Referring now to FIG. 2, which shows an exemplary downlink signal transmission pattern 200 for UE localization, in accordance with some embodiments of the present disclosure. Consider that there are a total of 8 RUs serving the cell 104 (i.e., RU1, RU2, RU3, . . . , RU8) which are configured to transmit 8 different downlink signals (i.e., RS1, RS2, . . . , RS8) in a periodic manner such that within a predefined time duration of 80 ms, RU1 is configured to transmit RS1 at a first time instance (t=0 ms), RU2 is configured to transmit RS2 at a second time instance (t=10 ms), RU3 is configured to transmit RS3 at a third time instance (t=20 ms) and so on, as shown in FIG. 2. In such RAN deployment, each RU makes only one downlink signal transmission within the predefined time duration of 80 ms. During subsequent predefined time durations of 80 ms, the RUs are configured to transmit the same unique downlink signals in the same sequential manner.

Consider that an exemplary user equipment (say UE 106-1) is entering the cell 104 at a time instance t=0 ms. Upon entering the cell 104, the UE 106-1 may start receiving the downlink signal transmissions from the RUs 1-8. In order to identify one or more RUs from the RUs 1-8 for serving the UE 106-1, the gNB 102 may instruct the UE 106-1 to separately transmit CSI report for each of the downlink signal transmissions within the time duration of 80 ms. As a result of this, UE 106-1 may transmit 8 CSI reports comprising signal strength measurements corresponding to the 8 downlink signal transmissions from the RUs 1-8. In the illustrative RAN deployment, the CSI reports are transmitted at a periodic interval of 10 ms. For instance, the CSI report corresponding to downlink signal transmission from RU1 at t=0 ms may be transmitted at the end of 10^{th} ms (i.e. close to expiry of 10^{th} ms), the CSI report corresponding to downlink signal transmission from RU1 at t=10 ms may be transmitted at the end of 20^{th} ms (i.e. close to expiry of 20 ms), and so on (as shown in FIG. 2). In such RAN deployment, within 80 ms, the UE 106-1 transmits 8 CSI reports to the gNB 102. Each CSI report may comprise signal strength measurements of a downlink signal transmission from a corresponding RU.

The signal strength measurements in a CSI report indicate the downlink signal corresponding to the signal strength measurements included in the CSI report. Since the gNB 102 is already aware of RU:RS association (i.e., the gNB is aware of which RU transmits which downlink signal), upon receiving the CSI reports from the UE 106-1, the gNB 102 may easily find out the RUs corresponding to each of the received CSI reports. In another non-limiting embodiment, in order to find out the RUs corresponding to each of the received CSI reports, the gNB 102, upon receiving the CSI reports from the UE 106-1, may co-relate the timing of the received CSI reports with the information present in the list to determine the RUs corresponding to each of the received CSI reports. The gNB may 102 then determine a mapping of a downlink signal with a corresponding RU based on the information present in the list. For example, for a CSI report received during 0<t mod 80<10, the downlink signal to RU mapping may be determined as 1:1 which means that the CSI report received during the time period of 0-10 ms comprises signal strength measurements corresponding to transmission of RS1 from RU1, whereas for a CSI report received during 40<t mod 80<50, the downlink signal to RU mapping may be determined as 5:5 which means that the CSI report received during the time period of 40-50 ms comprises measurements corresponding to transmission of downlink signal RS5 from RU5 (see FIG. 2). In this manner, the gNB 102 may determine which CSI report (or which signal strength measurement) corresponds to which RU. The gNB 102 may then select one or more RUs for serving the UE 106-1 based on the received CSI reports. The gNB 102 may compare the signal strength measurements of the received CSI reports with one or more predefined threshold values and select the RUs (for serving the UE 106-1) whose signal strength measurements satisfy the predefined threshold values. The gNB 102 may then transmit downlink data towards the UE 106-1 and receive uplink data from the UE 106-1 using the selected one or more RUs.

In one non-limiting embodiment, the signal strength measurements may comprise RSRP measurements between the UE 106-1 and the plurality of RUs 112 and/or pathloss measurements between the UE 106-1 and the plurality of RUs 112. The gNB 102 may select the RUs whose RSRP measurements exceed a predefined threshold measurement value and/or whose pathloss measurements are below a predefined threshold measurement value. Alternatively, or additionally, the gNB 102 may compare other signal strength measurements (e.g., SINR, RSSI, SNR etc.) with their corresponding threshold to select the one or more RUs for serving the UE 106-1.

Typically, modern UEs have limited capabilities in terms of a total number of different downlink signals that a UE may be configured to measure within a given time and a total number of different CSI reports that a UE may transmit within a given time. For instance, a UE may process only a limited number of different downlink signals within a given time and may report only a limited number of CSI reports within a given time. In such scenarios, it may be advantageous to share a downlink signal and a CSI reporting across multiple RUs for efficient UE localization. The forthcoming paragraphs now describe the UE localization techniques which use a minimal number of different downlink signals and a minimal number of different CSI reports.

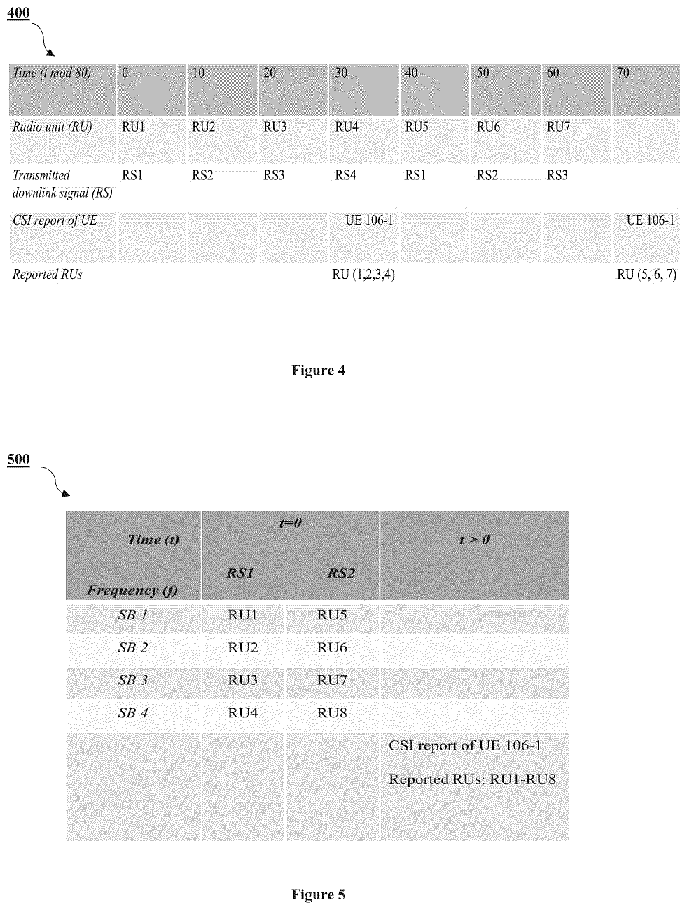

In one non-limiting embodiment of the present disclosure, in order to minimize the number of different downlink signals and the number of different CSI reports, the gNB 102 may time-share different downlink signals and CSI reporting across the plurality of RUs 112 (as shown in FIGS. 3-4). For instance, the gNB 102 may group the plurality of RUs 112 into one or more groups such that each group may comprise at least one RU. The number of RUs within each group may be the same or different. In a non-limiting embodiment, the number of RUs within each group may be based on a total number of different downlink signals that a UE may be configured to measure within a given time. For instance, when the number of RUs serving the cell is a multiple of the total number of different downlink signals then the number of RUs within each group is equal to a number of the different downlink signals that the UE may be configured to measure within a given time (as shown in FIG. 3). However, when the number of RUs serving the cell is not a multiple of the total number of different downlink signals then the number of RUs within one group may be different (typically less) from the number of RUs within each of the remaining groups of the one or more groups, the number of RUs within each of the remaining groups being equal to the number of the different downlink signals (as shown in FIG. 4).

Referring now to FIG. 3, which shows an exemplary downlink signal transmission pattern 300 for UE localization, in accordance with some embodiments of the present disclosure. Consider that there are a total of 8 RUs serving the cell 104 (i.e., RU1, RU2, RU3, . . . , RU8) which are grouped into 2 groups (Group 1 and Group 2) such that each group comprises only 4 RUs which may be configured to serve a user equipment (say UE 106-1) which is entering the cell 104 at t=0. Group 1 may comprise RUs 1, 2, 3, 4; and Group 2 may comprise RUs 5, 6, 7, 8.

For each group, the gNB 102 may configure each RU of the group to transmit a different wideband downlink signal to the UEs 106 at a unique time instance within a predefined time interval. For instance, as shown in FIG. 3, the gNB 102 may configure RU1-RU4 of Group 1 to transmit downlink signals RS1-RS4 at unique time instances 0 ms, 10 ms, 20 ms, and 30 ms, respectively within a predefined time interval of 40 ms. In such RAN deployment, the gNB 102 may instruct the UE 106-1 to transmit a single CSI report for each group at the end of the predefined time interval of 40 ms. For instance, in the exemplary illustration of FIG. 3, the gNB 102 may instruct the UE 106-1 to transmit a single CSI report at the end of 40^{th} ms, the single CSI report may comprise signal strength measurements corresponding to the transmissions of the downlink signals RS1-RS4 from the RU1-RU4 of Group 1. At the end of 40 ms, the gNB 102 may receive the CSI report from UE 106-1 comprising signal strength measurements of the transmissions of the downlink signals RS1-RS4 from the RU1-RU4 of Group 1.

The gNB 102 may repeat the transmissions of the different downlink signals RS1-RS4 in a same sequential manner for the other groups of RUs at time instances which are distinct from the unique time instances. For instance, the gNB 102 may configure RU5-RU8 of Group 2 to transmit downlink signals RS1-RS4 at time instances 40 ms, 50 ms, 60 ms, and 70 ms, respectively. At the end of 80 ms, the gNB 102 may receive the CSI report from UE 106-1 comprising signal strength measurements of the transmissions of downlink signals RS1-RS4 from RU5-RU8 of Group 2. Hence, by using a reporting interval of 40 ms (with 4 RUs reporting at a time), the gNB 102 may obtain signal strength measurements of all 8 RUs in every 80 ms.

It may be noted here that in such RAN deployment, a time duration between two consecutive downlink signal transmissions within a group and across the one or more groups is the same. For instance, the time duration between transmission of downlink signals RS1 and RS2 within each group is 10 ms and the time duration between transmission of downlink signals RS4 and RS1 across groups 1 and 2 is also 10 ms. Also, it may be noted that in the RAN deployment of FIG. 3, each downlink signal is transmitted 2 times from 2 different RUs within every 80 ms and each RU makes only one downlink signal transmission within every 80 ms. Also, within every 80 ms, UE 106-1 transmits 2 CSI reports to the gNB 102. Each CSI report may comprise signal strength measurements of downlink signal transmission from the one or more RUs of the respective group.

The gNB 102, upon receiving a CSI report from the UE 106-1 may use the information present in the list to determine mapping of downlink signals and RUs based on the timing of the CSI report. For example, for a CSI report received within a time 30<t mod 80<40, the gNB 102 may determine that the CSI report received during the time period of 30-40 ms comprises signal strength measurements corresponding to transmission of RS1-RS4 from RU1-RU4 respectively, whereas for a CSI report received during 70<t mod 80<80, the gNB 102 may determine that the CSI report received during the time period of 70-80 ms comprises signal strength measurements corresponding to transmission of RS1-RS4 from RU5-RU8 respectively (see FIG. 3). In this manner, the gNB 102 may determine which signal strength measurement corresponds to which RU. The gNB 102 may then select one or more RUs for serving the UE 106-1 based on the received CSI reports. In one non-limiting embodiment, the gNB 102 may compare the signal strength measurements of the received CSI reports with one or more predefined threshold values and select the RUs (for serving the UE 106-1) whose signal strength measurements satisfy the one or more predefined threshold values. The gNB 102 may then transmit downlink data towards the UE 106-1 and receive uplink data from the UE 106-1 using the selected one or more RUs.

In a similar manner, the gNB 102 may perform UE localization for each UE of the cell 104. For instance, for a different user equipment (say UE 106-2) which is entering the cell at a time instance t=20 ms, the gNB may assign the different RUs into 2 groups (Group 1 and Group 2) in such a manner that Group 1 comprises RUs 3, 4, 5, 6 transmitting downlink signals RS 3, 4, 1, 2 at time instances 20, 30, 40, 50 ms respectively; and Group 2 comprises RUs 7, 8, 1, 2 transmitting downlink signals RS 3, 4, 1, 2 at time instances 60, 70, 80 mod 80, 90 mod 80 ms (i.e., 60, 70, 0, 10 ms) respectively. The gNB 102 may receive a single CSI report from UE 106-2 after a time lapse of 40 ms (i.e., at the end of 60^{th} ms in FIG. 3), the single CSI report may comprise signal strength measurements corresponding to the transmissions of the downlink signals from the RU3-RU6 of Group 1. Similarly, the gNB 102 may receive subsequent CSI reports from UE 106-2 for downlink signal transmissions from Group 2 after a periodic time interval of 40 ms i.e., at the end of 100 mod 80 ms (or 20 ms). The gNB 102 may then select one or more RUs for serving the UE 106-2 based on the received CSI reports. In this manner, the CSI-reporting instances of different UEs can be staggered in time to distribute CSI processing load across time.

Referring now to FIG. 4, which shows an exemplary downlink signal transmission pattern 400 for UE localization, in accordance with some embodiments of the present disclosure. Consider that there are a total of 7 RUs serving the cell 104 (i.e., RU1, RU2, RU3, . . . , RU7) which are grouped into 2 groups (Group 1 and Group 2) such that Group 1 comprises RUs 1, 2, 3, 4; and Group 2 comprises RUs 5, 6, 7 (i.e., the number of RUs in each group is not same).

In such deployment, the gNB 102 may configure RU1-RU4 of Group 1 to transmit wideband downlink signals RS1-RS4 at time instances 0 ms, 10 ms, 20 ms, and 30 ms, respectively within a predefined time interval of 40 ms and the gNB 102 may receive a CSI report at the end of 40^{th} ms from UE 106-1 comprising signal strength measurements of the transmissions of the downlink signals RS1-RS4 from the RU1-RU4 of Group 1. For Group 2, the gNB 102 may configure RU5-RU7 to transmit downlink signals RS1-RS3 at time instances 40 ms, 50 ms, and 60 ms, respectively. However, the CSI report is received after the periodic time interval of 40 ms i.e., at the end of 80^{th}ms (i.e., the CSI reporting interval remains same even if the number of RUs in the one or more groups is different). The gNB 102 may then select one or more RUs for serving the UE 106-1 based on the received CSI reports.

In the embodiments explained in connection with FIGS. 2-4, each downlink signal transmission may occupy the whole frequency band i.e., the gNB 102 may configure the RUs 112 to transmit wideband downlink signals. In general, a signal which is transmitted wideband may occupy the whole frequency band while a signal which is transmitted sub-band may occupy a specific segment of the frequency band.

In another non-limiting RAN deployment, the gNB 102 may share different downlink signals and CSI reporting across the plurality of RUs 112 in frequency domain, as shown in FIG. 5. In such RAN deployment, the gNB 102 may partition the available wideband downlink bandwidth into a plurality of sub-bands and may group the plurality of RUs 112 into one or more groups such that each group may comprise one or more RUs. The number of RUs in each group may be less than or equal to a number of the plurality of sub-bands. In a non-limiting embodiment, the number of RUs within each group may be based on a total number of the plurality of sub-bands. For instance, when the number of RUs serving the cell is a multiple of the total number of sub-bands then the number of RUs within each group is equal to the number of sub-bands. However, when the number of RUs serving the cell is not a multiple of the total number of sub-bands then the number of RUs within one group may be less than the number of RUs within each of the remaining groups, the number of RUs within each of the remaining groups being equal to the number of the plurality of sub-bands.

Referring to FIG. 5, which shows a downlink signal transmission pattern 500 for UE localization in an exemplary RAN deployment, in accordance with some embodiments of the present disclosure. Consider that a wideband bandwidth of size 112 PRBs is partitioned into 4 sub-bands (i.e., SB1, SB2, SB3, and SB4) each having a bandwidth of 24 PRBs. Consider that there are a total of 8 RUs serving the cell 104 (i.e., RU1, RU2, RU3, . . . , RU8) which may be grouped into 2 groups (Group 1 and Group 2) such that each group comprises 4 RUs configured to serve a user equipment (say UE 106-1) which is entering the cell 104 at t=0 ms. Group 1 may comprise RUs 1, 2, 3, 4 and Group 2 may comprise RUs 5, 6, 7, 8.

The gNB 102 may configure all of the plurality of RUs 112 to transmit one or more downlink signals at a same time instance using the plurality of sub-bands. Specifically, at a particular time instance, the gNB 102 may configure each RU of a particular group of RUs to transmit a same downlink signal to the UE 106-1 in a unique sub-band of the plurality of sub-bands. Also, at the same particular time instance, the gNB 102 may configure each RU of another group of RUs to transmit a different downlink signal to the UE 106-1 in a unique sub-band of the plurality of sub-bands. In other words, a downlink signal transmitted from RUs of one group is different from a downlink signal transmitted from RUs of another group. For instance, in the exemplary RAN deployment of FIG. 5, the gNB 102 may configure RU1-RU4 of Group 1 to transmit a first downlink signal RS1 in the sub-bands SB1-SB4 at a first-time instance (t=0 ms). Further, the gNB 102 may configure RU5-RU8 of Group 2 to transmit a second downlink signal RS2 in the sub-bands SB1-SB4 respectively at the same first-time instance (t=0 ms).

In such RAN deployment, the gNB 102 may instruct the UE 106-1 to transmit a single CSI report for the one or more groups of RUs after the first-time instance. In particular, the gNB 102 may configure the UE 106-1 to report signal strength measurements on a sub-band granularity. For example, in the exemplary illustration of FIG. 5, the gNB 102 may instruct the UE 106-1 to transmit a single CSI report comprising sub-band level signal strength measurements corresponding to the transmissions of the downlink signals RS1, RS2 from the plurality of RUs 112 in the plurality of sub-bands SB1-SB4. The gNB 102 may receive the CSI report from UE 106-1 after the first-time instance (i.e., after t=0 ms in FIG. 5).

The gNB 102 may then process the received CSI report based on the mappings present in the list to determine the sub-band level signal strength measurements corresponding to the plurality of RUs 112. The gNB 102 may then select one or more RUs for serving the UE 106-1 based on the sub-band level signal strength measurements. In one non-limiting embodiment, the gNB 102 may compare the sub-band level signal strength measurements of the received CSI report with one or more predefined threshold values and select the RUs (for serving the UE 106-1) whose sub-band level signal strength measurements satisfy the one or more predefined threshold values. The gNB 102 may then transmit downlink data towards the UE 106-1 and receive uplink data from the UE 106-1 using the selected one or more RUs.

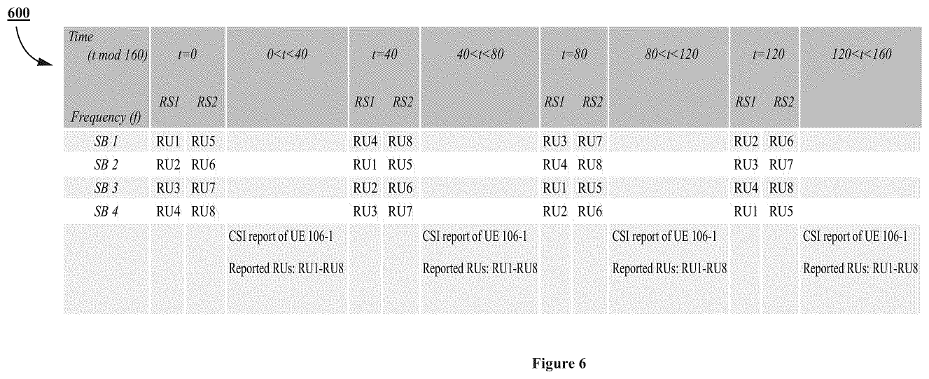

In another non-limiting RAN deployment, the gNB 102 may change mapping between sub-bands and RUs within each group of the one or more groups and repeat the processing performed at the first-time instance (t=0 ms) (as described above in connection with FIG. 5) at subsequent time instances (i.e., t=40 ms, 80 ms, 120 ms), as illustrated in FIG. 6. Particularly, the gNB 102 may repeat the processing performed at the first-time instance at the subsequent time instances for each group in such a manner that at each subsequent time instance, each RU of a particular group may transmit its corresponding downlink signal to the UE 106-1 in a sub-band which is different from the unique sub-band(s) previously used by the RU. The gNB 102 may receive one CSI report from UE 106-1 after each of the subsequent time instances, as shown in FIG. 6, which shows a downlink signal transmission pattern 600 for UE localization in an exemplary RAN deployment, in accordance with some embodiments of the present disclosure.

As shown in FIG. 6, at a second time instance (t=40 ms), the gNB 102 may repeat the transmissions of RS1 from RU1-RU4 of Group 1 such that each RU of Group 1 transmits RS1 in a sub-band which is different from the sub-band previously used by the RU. For instance, RU1 may transmit RS1 in SB2, RU2 may transmit RS1 in SB3, RU3 may transmit RS1 in SB4, and RU4 may transmit RS1 in SB1. Similarly, at the same second time instance (t=40 ms), the gNB 102 may repeat the transmissions of RS2 from RU5-RU8 of Group 2 such that each RU of Group 2 transmits RS2 in a sub-band which is different from the sub-band previously used by the RU. For instance, RU5 may transmit RS2 in SB2, RU6 may transmit RS2 in SB3, RU7 may transmit RS2 in SB4, and RU8 may transmit RS2 in SB1 (as shown in FIG. 6). After the second time instance and before a third time instance (i.e., between 40 ms-80 ms), the gNB 102 may receive a single CSI report comprising sub-band level signal strength measurements corresponding to the transmissions of the downlink signals RS1, RS2 (at the second time instance) from the plurality of RUs 112.

The gNB 102 may repeat the processing performed at the first/second time instance at the subsequent time instances (i.e., at t=80 ms and t=120 ms) and may receive a single CSI report after each subsequent time instance (as shown in FIG. 6). It may be noted that a total number of the different time instances at which the downlink signals are transmitted or a total number of different CSI reports which are received by the gNB 102 may be equal to a total number of the plurality of sub-bands.

The gNB 102 may then average the sub-band level signal strength measurements which belong to the same RU to determine an average wideband signal strength for each RU of the plurality of RUs 112 across the plurality of sub-bands. For instance, to determine an average wideband signal strength for RU1 across entire bandwidth or across the plurality of sub-bands, the gNB 102 may take an average of the sub-band level signal strength measurements corresponding to the transmissions of RS1 from RU1 at the various time instances (i.e., t=0 ms, 40 ms, 80 ms, and 120 ms). Averaging the sub-band level signal strength measurements may provide a more reliable estimate of signal strength for each RU. The gNB 102 may then compare the average signal strengths corresponding to the plurality of RUs 112 with one or more predefined threshold values and select one or more RUs (for serving the UE 106-1) whose average signal strengths satisfy the one or more predefined threshold values. The gNB 102 may then transmit downlink data towards the UE 106-1 and receive uplink data from the UE 106-1 using the selected one or more RUs.

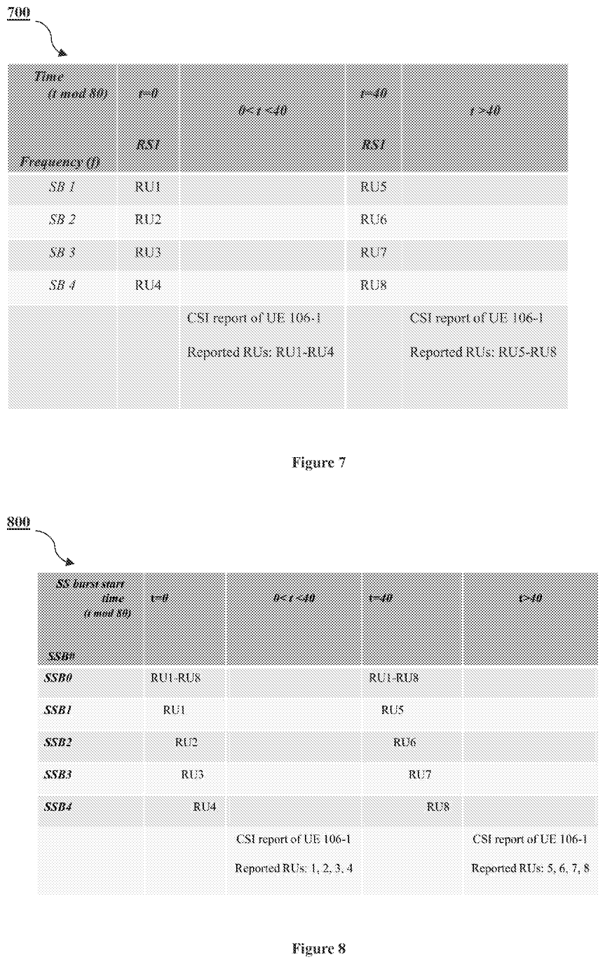

In another non-limiting embodiment, the gNB 102 may share different downlink signals and CSI reporting across the plurality of RUs 112 in both frequency and time domain, as illustrated in FIG. 7. Referring now to FIG. 7, which illustrates another downlink signal transmission pattern 700 for UE localization in an exemplary RAN deployment. In such RAN deployment, the gNB 102 may partition the available wideband downlink bandwidth into a plurality of sub-bands and may group the plurality of RUs 112 into one or more groups in the manner as described above in connection with FIG. 5.

The gNB 102 may configure each RU of a particular group to transmit a same downlink signal at a particular time instance to a user equipment (say UE 106-1) in a unique sub-band of the plurality of sub-bands. For instance, as shown in FIG. 7, the gNB 102 may configure RU1-RU4 of Group 1 to transmit a same downlink signal RS1 in sub-bands SB1-SB4 at a first-time instance (t=0 ms). In such RAN deployment, the gNB 102 may instruct the UE 106-1 to transmit a single CSI report for each group after the particular time instance. The single CSI report may comprise sub-band level signal strength measurements corresponding to the transmissions of the downlink signal RS1 from RU1-RU4 of Group 1. After the particular time instance, the gNB 102 may receive the single CSI report from UE 106-1 comprising sub-band level signal strength measurements of the transmissions of the downlink signal RS1 from RU1-RU4 of Group 1.

The gNB 102 may repeat the transmissions of the same downlink signal for another group of RUs in a unique sub-band of the plurality of sub-bands but at a time instance which is distinct from the particular time instance. For instance, at a second-time instance (t=40 ms), the gNB 102 may configure RU5-RU8 of Group 2 to transmit the same downlink signal RS1 in sub-bands SB1-SB4, respectively. After the second time instance, the gNB 102 may receive another CSI report from UE 106-1 comprising sub-band level signal strength measurements of the transmissions of the downlink signal RS1 from RU5-RU8 of Group 2.

The gNB 102 may then select one or more RUs for serving the UE 106-1 based on the sub-band level signal strength measurements included in the CSI reports. For instance, the gNB 102 may compare the sub-band level signal strength measurements of the received CSI reports with one or more predefined threshold values and select one or more RUs (for serving the UE 106-1) whose sub-band level signal strength measurements satisfy the one or more predefined threshold values. The gNB 102 may then transmit downlink data towards the UE 106-1 and receive uplink data from the UE 106-1 using the selected one or more RUs.

In one non-limiting embodiment of the present disclosure, the gNB 102 may determine an average wideband signal strength for each RU of the plurality of RUs 112 across the plurality of sub-bands using the above techniques described in connection with FIG. 6 and then select one or more RUs (for serving the UE 106-1) whose average signal strengths satisfy the one or more predefined threshold values.

It may be noted here that in the embodiments explained in connection with FIGS. 2-7, the downlink signals transmitted by the RUs 119 may comprise Channel State Information Reference Signals (CSI-RSs).

The following paragraphs now describe Synchronization Signal Block (SSB) based UE localization techniques.

In 5G NR, the gNB 102 periodically transmits Synchronization Signal Blocks. Typically, the gNB 102 periodically transmits (e.g., with a periodicity between 5 and 160 ms) the SSBs in bursts (e.g., 5 ms bursts). Each SSB burst may include up to N different SSBs (N=8 for FR1 frequency range and N=64 for FR2 frequency range) which are usually transmitted in distinct time resources and typically using different beams. Each SSB of a SSB burst may be identified by a different SSB index. Generally, a SSB carries synchronization signal and initial system information which may be required by a UE for initial attach to a network. In addition to CSI-RSs or as an alternative of CSI-RSs, the gNB 102 may configure the UEs to perform CSI measurements on the different SSBs. By transmitting different SSBs from different RUs, the gNB 102 may utilize corresponding CSI measurements for UE localization.

In one non-limiting RAN deployment of the present disclosure, the gNB 102 may time-share different downlink signals (i.e., SSB indices) and CSI reporting across the plurality of RUs 112 for UE localization, as shown in FIG. 8. For instance, the gNB 102 may group the plurality of RUs 112 into one or more groups such that each group may comprise at least one RU. The number of RUs within each group may be the same or different. In a non-limiting embodiment, the number of RUs within each group may depend on a total number of different downlink signals that a UE may be configured to measure within a given time. For instance, when the number of RUs serving the cell is a multiple of the total number of different downlink signals then the number of RUs within each group is equal to a number of the different downlink signals that the UE may be configured to measure within a given time. However, when the number of RUs serving the cell is not a multiple of the total number of different downlink signals then the number of RUs within one group may be different (typically less) from the number of RUs within each of the remaining groups of the one or more groups, the number of RUs within each of the remaining groups being equal to the number of the different downlink signals. This RAN deployment may be explained in detail with the help of FIG. 8.

Referring now to FIG. 8, which shows downlink signal transmission pattern 800 for UE localization in an exemplary RAN deployment, in accordance with some embodiments of the present disclosure. Consider that there are a total of 8 RUs serving the cell 104 (i.e., RU1, RU2, RU3, . . . , RU8) which are grouped into 2 groups (Group 1 and Group 2) such that each group comprises only 4 RUs which may be configured to serve a user equipment (say UE 106-1) which is entering the cell 104 at t=0 ms. Group 1 may comprise RUs 1, 2, 3, 4; and Group 2 may comprise RUs 5, 6, 7, 8.

In such RAN deployment, the gNB 102 may periodically transmit the same SSB burst from each group of RUs. The SSB burst may comprise one or more SSB indices which may be transmitted from the one or more RUs of each group in a same sequential manner. For each group of RUs, the gNB 102 may configure each RU of the group to transmit a different SSB index of the SSB burst to the UE 106-1 at a unique time instance within a predefined time interval. For instance, as shown in FIG. 8, the gNB 102 may configure RU1-RU4 of Group 1 to start transmission of the SSB burst at a first-time instance (i.e., at 0 ms) such that downlink signals SSB1-SSB4 of the SSB burst are transmitted from RU1-RU4, respectively, at unique time instances (say 1 ms, 2 ms, 3 ms, and 4 ms) within the predefined time interval. Here, the time duration between two consecutive SSB transmissions within the group is the same (i.e., 1 ms). In such RAN deployment, the gNB 102 may instruct the UE 106-1 to transmit a single CSI report for each group after the predefined time interval. For instance, in the exemplary illustration of FIG. 8, the gNB 102 may instruct UE 106-1 to transmit a single CSI report after the predefined time interval, the single CSI report may comprise signal strength measurements corresponding to the transmissions of the downlink signals SSB1-SSB4 from the RU1-RU4 of Group 1. The gNB 102 may receive the CSI report from UE 106-1 after the predefined time interval. The predefined time interval may be chosen such that within the predefined time interval, each RU of the group makes one SSB transmission.

The gNB 102 may repeat the transmissions of the different downlink signals SSB1-SSB4 in a same sequential manner for the other groups of RUs. For instance, as shown in FIG. 8, the gNB 102 may configure RU5-RU8 of Group 2 to start transmission of the same SSB burst at a second time instance (i.e., at 40 ms) such that RU5-RU8 of Group 2 are configured to transmit downlink signals SSB1-SSB4 respectively (say at time instances 41 ms, 42 ms, 43 ms, and 44 ms). After the predefined time interval, the gNB 102 may receive the CSI report from the UE 106-1 comprising signal strength measurements of the transmissions of downlink signals SSB1-SSB4 from RU5-RU8 of Group 2 (as shown in FIG. 8).

The gNB 102, upon receiving the CSI reports from the UE 106-1, may co-relate the timing of the received CSI reports with the mappings present in the list to determine the RUs corresponding to each of the received CSI reports. The gNB 102 may then select one or more RUs for serving the UE 106-1 based on the signal strength measurements included in the CSI reports. For instance, the gNB 102 may compare the signal strength measurements of the received CSI reports with one or more predefined threshold values and select one or more RUs (for serving the UE 106-1) whose signal strength measurements satisfy the one or more predefined threshold values. The gNB 102 may then transmit downlink data towards the UE 106-1 and receive uplink data from the UE 106-1 using the selected one or more RUs.

In one non-limiting embodiment, while time-sharing different SSB indices across different RUs of the one or more groups, the gNB 102 may reserve one or more SSB indices of the SSB burst for initial attach of the UEs 106 to the network. Such reserved SSB indices may have a fixed transmission from all of the plurality of RUs 112 at all periodic time instances. For example, as shown in FIG. 8, SSB0 may be reserved for initial attach of the UE 106-1 and the reserved SSB0 may be broadcasted from all of RU1-RU8 at both the first and the second time instances (i.e., at t=0 ms and t=40 ms, as shown in FIG. 8). The one or more reserved SSB indices may be transmitted at a slightly higher power compared to the other SSBs to ensure that the one or more SSB indices are always preferred by the UE 106-1 for the purpose of initial attach.

In one non-limiting embodiment of the present disclosure, the SSB based localization may be used along with CSI-RS based localization for hierarchical coarse and fine UE localization. In such RAN deployment, the gNB 102 may initially use the SSB based localization to identify one or more RUs from the plurality of RUs 112 for temporarily serving a user equipment (say UE 106-1). The gNB 102 may use the CSI-RS based localization to identify at least one RU either from the identified one or more RUs or from the plurality of RUs 112 for finally serving the UE 106-1. The gNB 102 may use the identified one or more RUs for temporarily serving the UE 106-1 till the time the at least one RU is finally identified for serving the UE 106-1.

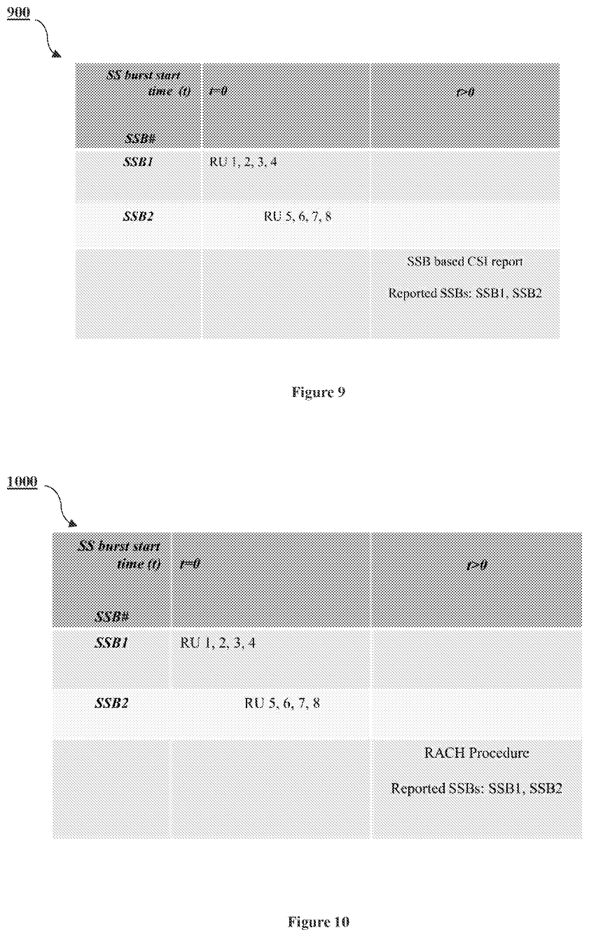

Referring now to FIG. 9, which shows downlink signal transmission pattern 900 for UE localization in an exemplary RAN deployment, in accordance with some embodiments of the present disclosure. In such RAN deployment, the gNB 102 may group the plurality of RUs 112 into one or more groups such that each group may comprise at least one RU. The number of RUs within each group may be the same or different. Consider that there are a total of 8 RUs serving the cell 104 (i.e., RU1, RU2, RU3, . . . , RU8) which may be grouped into 2 groups (Group 1 and Group 2) each group comprising 4 RUs i.e., Group 1 may comprise RUs 1, 2, 3, 4; and Group 2 may comprise RUs 5, 6, 7, 8.

Consider that the user equipment (UE 106-1) is entering the cell 104 at t=0. In such RAN deployment, the gNB 102 may configure all RUs of one group to transmit a same SSB index at a same time instance. Also, the gNB 102 may configure all RUs of another group to transmit another SSB index at another time instance. For instance, as shown in FIG. 9, the gNB 102 may configure all RUs of Group 1 i.e., RU1-RU4 to transmit a first SSB index (i.e., SSB1) at a first-time instance (say t=0 ms). Further, the gNB 102 may configure all RUs of Group 2 i.e., RU5-RU8 to transmit a second SSB index (i.e., SSB2) at a second-time instance (say t=2.5 ms) which is different from the first-time instance. The first and second SSB indices i.e., SSB1 and SSB2 may be a part of the same SSB burst. The gNB 102 may instruct the UE 106-1 to transmit a single SSB based CSI report comprising signal strength measurements corresponding to the SSB transmissions from the one or more groups. For instance, in the exemplary illustration of FIG. 9, the gNB 102 may instruct UE 106-1 to transmit a SSB based CSI report after the second-time instance, where the SSB based CSI report may comprise signal strength measurements corresponding to the transmissions of SSB1 and SSB2 from Groups 1 and 2, respectively. The signal strength measurements corresponding to the transmissions of a particular SSB may comprise aggregate signal strength measurements corresponding to transmissions of the particular SSB from all RUs of the corresponding group. Once the transmissions of SSBs are completed from all groups, the gNB 102 may receive the SSB based CSI report from UE 106-1. For instance, in the illustration of FIG. 9, the gNB 102 may receive the SSB based CSI report after the second time instance (i.e., t=2.5 ms).

The gNB 102 may then select one or more SSBs for serving the UE 106-1 based on the signal strength measurements included in the received CSI report. For instance, the gNB 102 may compare the signal strength measurements of the received SSB based CSI report with a predefined threshold value and select strongest received SSBs for serving the UE 106-1 (i.e., the SSBs whose signal strength measurements satisfy one or more one or more predefined threshold conditions). The gNB 102 may then serve the UE 106-1 using the RUs corresponding to selected SSB. For instance, in the exemplary illustration of FIG. 9, the gNB 102 may select SSB2 and accordingly RU5-RU8 for temporarily serving the UE 106-1. This localization of UE 106-1 may be named as ‘coarse localization’.

In one non-limiting embodiment, the gNB may perform the ‘coarse localization’ during initial attachment of the user equipment (UE 106-1) to the network. As explained above, 5G NR allows multiple SSBs each with a different index to be transmitted by the gNB 102 from one or more RUs. For instance, as shown in the downlink signal transmission pattern 1000 of FIG. 10, where SSB1 is transmitted from RU1-RU4 and SSB2 is transmitted from RU5-RU8. In some configurations, each of these SSBs are transmitted using a different downlink fine beam. Each of the SSB transmissions may be associated with a unique time and/or frequency occasion or RACH opportunity. When multiple SSBs are transmitted using different beams, the UE 106-1 may measure each of the SSBs. The UE 106-1 may choose a SSB received with a strongest signal strength using the techniques as discussed in connection with FIG. 9 and may transmit a RACH preamble using the RACH opportunity associated with the chosen SSB. On detecting the RACH preamble, the gNB 102 may determine the SSB chosen by the UE 106-1, and hence the beam and RUs to serve the UE 106-1. In other words, during initial attachment, the UE 106-1 may indicate its preferred SSB indirectly by transmitting the RACH preamble that is mapped to the SSB of interest. The gNB 102 may then serve the UE 106-1 using the RUs corresponding to the chosen SSB. For instance, in the exemplary illustration of FIG. 10, the gNB 102 may select SSB2 and accordingly RU5-RU8 for temporarily serving the UE 106-1. Hence, by transmitting different SSBs from different RUs, the RUs from which the UE 106-1 receives the strongest signal may be identified during the initial attach itself.

The gNB 102 may perform ‘fine localization’ for selecting one or more RUs for finally serving the UE 106-1. In one non-limiting embodiment, performing the fine localization may comprise performing CSI-RS based localization on the RUs which are identified based on coarse localization using the techniques as described in connection with FIGS. 2-7. For instance, in the exemplary illustration of FIGS. 9-10, the gNB 102 may perform CSI-RS based localization on the RU5-RU8 using the techniques as described in connection with FIGS. 2-7 to select one or more RUs from RU5-RU8 for finally serving the UE 106-1.

In another non-limiting embodiment, performing the fine localization may comprise performing CSI-RS based localization on all of the plurality of RUs 112 for selecting one or more RUs for finally serving the UE 106-1, using the techniques as described in connection with FIGS. 2-7. In such embodiment, the selected one or more RUs may be from the RUs which are identified based on coarse localization (i.e., RU5-RU8) for temporarily serving the UE 106-1, or from the plurality of RUs 112, or a mix of the RUs which are identified based on coarse localization and the plurality of RUs 112.

Once the UE localization is completed using any of the above-mentioned techniques discussed in connection with FIGS. 2-10, the gNB 102 may configure the selected one or more RUs for the UE 106-1 such that downlink data can be wirelessly transmitted to/from the selected one or more RUs. The gNB 102 may transmit downlink data for UE 106-1 to only the RUs which are selected for serving the UE 106-1. The downlink data may be transmitted over the fronthaul network 120 from the DU 110 serving the cell 104. The downlink data for the UE 106-1 may not be transmitted to other RUs (which are not part of the selected one or more RUs).

In one non-limiting embodiment, the one or more RUs which are selected for serving a particular UE (e.g., UE 106-1) may be different from the one or more RUs which are selected for serving another UE (e.g., UE 106-2). In such embodiment, a set of the one or more RUs which are selected for serving the particular UE 106-1 may be referred to as “simulcast zone” for the particular UE. The respective simulcast zone may vary from UE to UE.

In one non-limiting embodiment, the downlink signal transmissions as described in connection with FIGS. 2-10 may be performed periodically or in response to occurrence of a specific condition or event e.g., if a new UE is entering the cell 104, if an already admitted UE moves from one location to another location within the cell 104, if a previous localization of a UE is not optimal, if there is change in network configuration (e.g., addition of new RUs within the cell 104, removal of RUs from the cell 104 etc.), but not limited thereto. Hence, the one or more RUs which are selected for serving a particular UE (e.g., UE 106-1) may change based on one or more of the specific conditions/events.

The present disclosure discloses various techniques of UE localization for various types of RAN deployments. The selection of a particular UE localization technique may depend on one or more factors including: a type of downlink signals (e.g., whether to use CSI-RS or SSB or both for UE localization), a number of downlink signals to be used for UE localization, Frequency Division Duplex (FDD) and/or Time Division Duplex (TDD) patterns to be used for transmission of the downlink signals, capability of UEs in terms of downlink signal processing and CSI reporting, but not limited thereto.

In the embodiments discussed in connection with FIGS. 2-10, the UE localization is described as being implemented by a multi-RU gNB 102 of the type described above in connection with FIG. 1. More specifically, the operations of FIGS. 2-10 may be performed by the DU 110 of the gNB 102. Also, in FIGS. 2-10 the UE localization is described as being performed for a particular UE 106-1. However, the present disclosure is not limited thereto and in general the UE localization may be performed for any UE 106 which may be served by the gNB 102.

In FIGS. 2-10, only one downlink signal transmission interval (i.e., time within which each RU of the plurality of RUs performs one downlink signal transmission) has been shown for the sake of simplicity. However, the present disclosure is not limited thereto and in general the downlink signal transmission interval may be repeated in a cyclic manner. In the present disclosure, the plurality of RUs 112 refers to all RUs which are serving the cell 104. However, the present disclosure is not limited thereto and in general only the RUs present in the neighborhood of the UE 106-1 (i.e., only the RUs that are physically close to the UE 106-1) may be included in the plurality of RUs 112 and the UE localization may be performed only for those neighboring RUs.

The present disclosure provides various technical advantages. For instance, the present disclosure describes UE localization techniques which take into account the processing capability of user equipment. Particularly, the techniques of the present disclosure use a minimal number of different downlink signals and a minimal number of different CSI reports for UE localization, thereby ensuring better resource utilization, increased system throughput, and enhanced quality of service. Further, whenever there is any change in network configurations of the RAN system, the techniques of the present disclosure may quickly update serving RUs for the UEs (without any interruptions or connectivity loss), thereby improving the user experience of already admitted UEs. Further, the techniques of the present disclosure provide mechanisms for serving newly admitted UEs from the attach time itself.

In one non-limiting embodiment, the RAN communication system 100 may be configured to support frequency reuse. As used here, “downlink frequency reuse” refers to situations where separate downlink data intended for different UEs is simultaneously wirelessly transmitted to the UEs using the same physical resource blocks (PRBs) for the same cell 104. Such reuse UEs may also be referred to as being “in reuse” with each other. For those PRBs where downlink frequency reuse is used, each of the multiple reuse UEs is served by a different subset of the plurality of RUs 112, where no RU is used to serve more than one UE for those reused PRBs. That is, for the reused PRBs, the simulcast zone for each of the multiple reuse UEs does not include any RU that is included in the simulcast zone of any of the other reuse UEs. Typically, these situations arise where the reuse UEs are sufficiently physically separated from each other so that the co-channel interference resulting from the different wireless downlink transmissions is sufficiently low.

In some of the above embodiments (specifically which describe time-sharing of downlink signals across the RUs 112), time restriction for signal strength measurements may be enabled to prevent UEs from averaging signal strength measurements made on a particular downlink signal across time. When the time restriction for signal strength measurements is enabled, a UE reports only instantaneous signal strength measurements corresponding to a last transmission of a particular downlink signal. In other words, in such configuration, the CSI reporting is configured such that one CSI reporting instance occurs between two successive transmissions of the particular downlink signal (e.g., CSI-RS). Thus, there would be no averaging of the signal strength measurements corresponding to two or more downlink transmissions of the particular downlink signal. To achieve this (i.e., to ensure that a UE does not average signal strength measurements corresponding to two or more downlink transmissions of the particular downlink signal across time), the gNB 102 explicitly configures the UE to report the instantaneous signal strength measurements. By instantaneous it is meant here that the gNB 102 configures the UE to not wait for subsequent transmissions of the particular downlink signal and instead reports signal strength measurements corresponding to a last transmission of the particular downlink signal before a subsequent transmission of the particular downlink signal occurs. Thus, the techniques of present disclosure enable instantaneous reporting of the signal strength measurements corresponding to a last transmission of the particular downlink signal transmission, thereby avoiding averaging of the signal strength measurements (across time) of two or more downlink transmissions of the particular downlink signal.

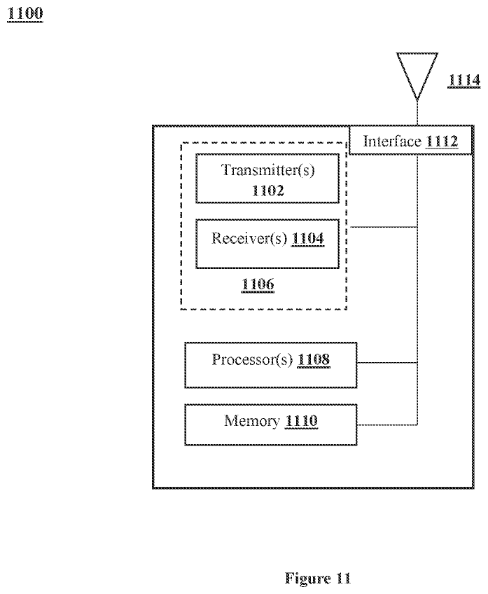

Referring now to, FIG. 11 which shows a high-level block diagram of an apparatus 1100 where the UE localization techniques consistent with the present disclosure may be implemented, in accordance with some embodiments of the present disclosure. The apparatus 1100 may comprise at least one transmitter 1102, at least one receiver 1104, at least one processor 1108, at least one memory 1110, at least one interface 1112, and at least one antenna 1114. The at least one transmitter 1102 may be configured to transmit data/information to one or more nodes/devices using the antenna 1114 and the at least one receiver 1104 may be configured to receive data/information from the one or more nodes/devices using the antenna 1114. The at least one transmitter and receiver may be collectively implemented as a single transceiver module 1106. In one non-limiting embodiment, the at least one processor 1108 may be communicatively coupled with the transceiver 1106, memory 1110, interface 1112, and antenna 1114 for implementing the above-described UE localization techniques.

The at least one processor 1108 may include, but not restricted to, microprocessors, microcomputers, micro-controllers, central processing units, state machines, logic circuitries, and/or any devices that manipulate signals based on operational instructions. A processor may also be implemented as a combination of computing devices, e.g., a combination of a plurality of microprocessors or any other such configuration. The at least one memory 1110 may be communicatively coupled to the at least one processor 1108 and may comprise various instructions, information related to downlink signal transmission patterns, the list comprising the mappings among RUs and downlink signal(s) and mappings among CSI reporting(s) and RUs etc. The at least one memory 1110 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The at least one processor 1108 may be configured to execute one or more instructions stored in the memory 1110.

The interfaces 1112 may include a variety of software and hardware interfaces, for example, a web interface, a graphical user interface, an input device-output device (I/O) interface, a network interface and the like. The I/O interfaces may allow the apparatus 1100 to communicate with one or more nodes/devices either directly or through other devices. The network interface may allow the apparatus 1100 to interact with one or more networks either directly or via any other network.

In one non-limiting embodiment, the apparatus 1100 may be any of: the base station (gNB) or the base station system 102, a part of the base station 102 (e.g., the CU 108, the DU 110, the RU 112, or any other equivalent entity e.g., BBU, RRH), but not limited thereto. In the above embodiments (described in conjunction with FIGS. 2-10), it has been shown that the UE localization techniques are being implemented with the help of the base station system or the gNB 102. However, in particular, the UE localization techniques of the present disclosure may be implemented with the help of the DU 110 or any other equivalent entity.

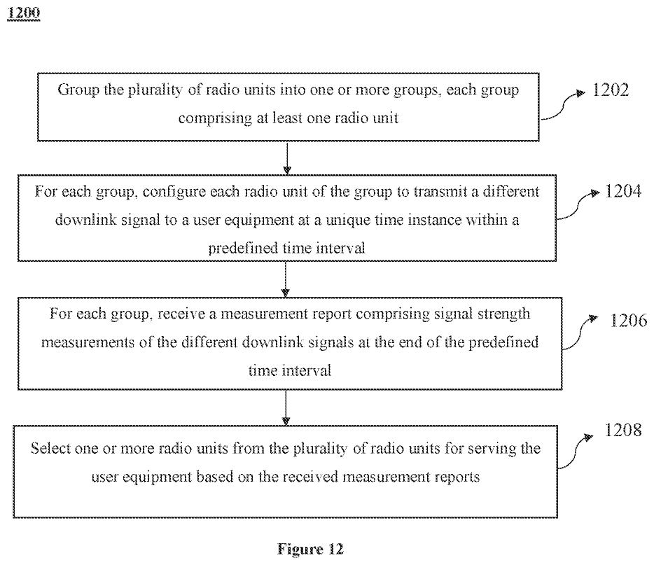

Referring now to FIGS. 12-16 which illustrate exemplary UE localization methods, according to various embodiments of the present disclosure. The methods described in FIGS. 12-16 may be performed using a base station system 102 comprising: at least one BBU to perform at least some baseband processing; and a plurality of radio units (RUs) 112 to wirelessly communicate with a plurality of user equipment (UEs) 106 via a respective set of one or more antennas 118. The at least one BBU and the plurality of RUs 112 may be communicatively coupled with each other. In particularly, the methods described in FIGS. 12-16 may be performed by the BBU which may comprise at least one DU 110.

Referring now to FIG. 12, a flowchart is described illustrating an exemplary UE localization method 1200, according to an embodiment of the present disclosure. The method 1200 is merely provided for exemplary purposes, and embodiments are intended to include or otherwise cover any UE localization methods or procedures.

The method 1200 may include, at block 1202, grouping a plurality of RUs 112 into one or more groups, each group comprising at least one RU. For example, the base station system or gNB 102 may be configured to group the plurality of RUs 112 into one or more groups.

At block 1204, the method 1200 may include for each group, configuring each RU of the group to transmit a different downlink signal to a UE at a unique time instance within a predefined time interval. The transmissions of the different downlink signals for one group may be repeated in a same sequential manner for another group at time instances distinct from the unique time instances. A time duration between two consecutive downlink signal transmissions within a group and across the one or more groups may be the same. For example, the system 102 may be configured to configure each RU of the group to transmit the different downlink signal to the UE at the unique time instance within the predefined time interval.

At block 1206, the method 1200 may include for each group, receiving a measurement report comprising signal strength measurements of the different downlink signals at the end of the predefined time interval. For example, the system 102 may be configured to receive the measurement report comprising signal strength measurements of the different downlink signals at the end of the predefined time interval.

At block 1208, the method 1200 may include selecting one or more RUs from the plurality of RUs 112 for serving the UE based on the received measurement reports. For example, the system 102 may be configured to select one or more RUs from the plurality of RUs 112 for serving the UE based on the received measurement reports.

In one non-limiting embodiment of the present disclosure, the method 1200 may further comprise comparing the signal strength measurements of the downlink signals with a predefined threshold value and selecting the one or more RUs from the plurality of RUs 112 for serving the UE based on a result of the comparison. For example, the system 102 may be configured to compare the signal strength measurements of the downlink signals with the predefined threshold value and select the one or more RUs from the plurality of RUs 112 for serving the UE based on the result of the comparison.

In one non-limiting embodiment of the present disclosure, the operation of block 1202 i.e., configuring each RU of the group to transmit a different downlink signal may comprise configuring each RU of the group to transmit a wideband downlink signal to the UE. For example, the system 102 may be configured to configure each RU of the group to transmit the wideband downlink signal to the UE.

In one non-limiting embodiment, the different downlink signals may comprise Channel State Information Reference Signals (CSI-RSs). In one non-limiting embodiment, each of the one or more groups may comprise distinct RUs. In one non-limiting embodiment, the one or more RUs for serving the UE may change based on one or more factors. In one non-limiting embodiment, each of the plurality of RUs 112 may be configured to serve the same cell.

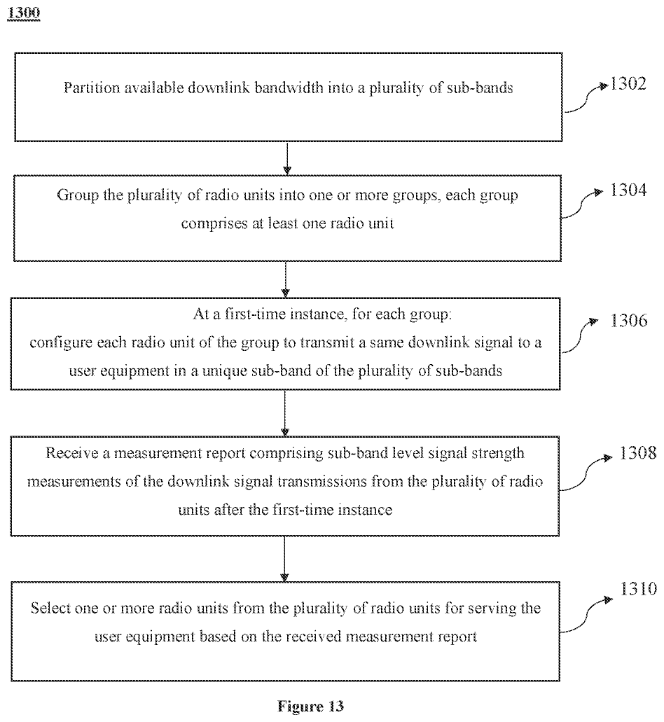

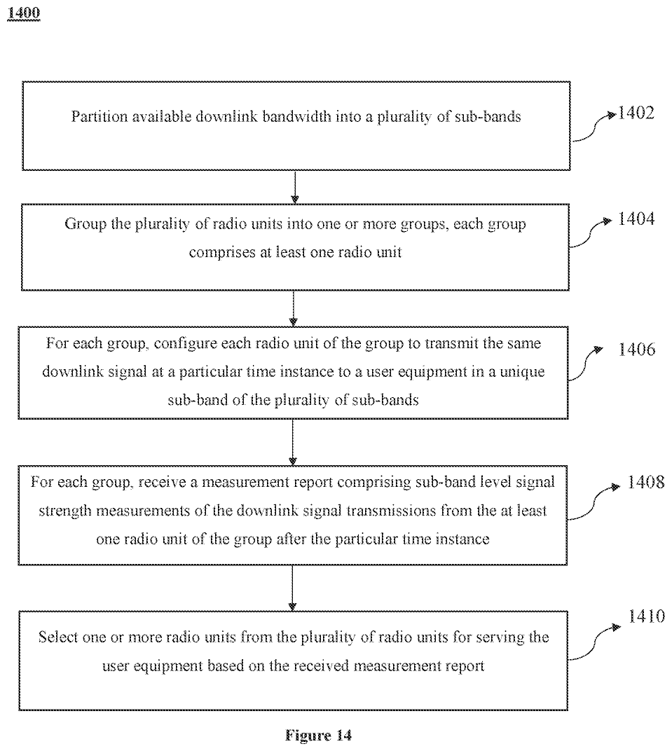

Referring now to FIG. 13, a flowchart is described illustrating an exemplary UE localization method 1300, according to an embodiment of the present disclosure. The method 1300 is merely provided for exemplary purposes, and embodiments are intended to include or otherwise cover any UE localization methods or procedures.

The method 1300 may include, at block 1302, partitioning available downlink bandwidth into a plurality of sub-bands. For example, the system 102 may be configured to partition the available downlink bandwidth into the plurality of sub-bands.

At block 1304, the method 1300 may include grouping the plurality of RUs 112 into one or more groups. For example, the system 102 may be configured to group the plurality of RUs 112 into one or more groups. Each group may comprise at least one RU and a number of the at least one RU in each group may be less than or equal to a number of the plurality of sub-bands.

At block 1306, the method 1300 may include at a first-time instance, for each group: configuring each RU of the group to transmit a same downlink signal to a UE in a unique sub-band of the plurality of sub-bands. The downlink signal transmitted from at least one RU of one group may be different from a downlink signal transmitted from at least one RU of another group. For example, the system 102 may be configured to configure each RU of the group to transmit the same downlink signal to the UE in the unique sub-band of the plurality of sub-bands.

At block 1308, the method 1300 may include receiving a measurement report comprising sub-band level signal strength measurements of the downlink signal transmissions from the plurality of RUs 112 after the first-time instance. For example, the system 102 may be configured to receive the measurement report comprising the sub-band level signal strength measurements of the downlink signal transmissions from the plurality of RUs 112 after the first-time instance.

At block 1310, the method 1300 may include selecting one or more RUs from the plurality of RUs 112 for serving the UE based on the received measurement report. For example, the system 102 may be configured to select one or more RUs from the plurality of RUs 112 for serving the UE based on the received measurement reports.

In one non-limiting embodiment of the present disclosure, the method 1300 may further comprise comparing the sub-band level signal strength measurements of the downlink signal transmissions with a predefined threshold value and selecting the one or more RUs from the plurality of RUs 112 for serving the UE based on a result of the comparison. For example, the system 102 may be configured to compare the sub-band level signal strength measurements of the downlink signal transmissions with the predefined threshold value and select the one or more RUs from the plurality of RUs 112 for serving the UE based on the result of the comparison.

In one non-limiting embodiment of the present disclosure, the method 1300 may further comprise repeating the operations of blocks 1306-1308 at subsequent time instances. For each subsequent time instance, each of the at least one RU of the group may transmit the downlink signal to the UE in a sub-band which is different from the unique sub-bands previously used by the RU. In such embodiment, a number of the different time instances at which the downlink signals are transmitted may be equal to the number of the plurality of sub-bands.

In one non-limiting embodiment of the present disclosure, the method 1300 may further comprise determining an average signal strength for each RU based on the sub-band level signal strength measurements of each RU across the plurality of sub-bands, and selecting one or more RUs from the plurality of RUs 112 for serving the UE based on the average signal strengths. For example, the system 102 may be configured to determine the average signal strength for each RU based on the sub-band level signal strength measurements of each RU across the plurality of sub-bands, and select the one or more RUs from the plurality of RUs 112 for serving the UE based on the average signal strengths.

In one non-limiting embodiment of the present disclosure, the method 1300 may further comprise comparing the average signal strengths for each RU with a predefined threshold value and selecting the one or more RUs from the plurality of RUs 112 for serving the UE based on a result of the comparison. For example, the system 102 may be configured to compare the average signal strengths for each RU with the predefined threshold value and select the one or more RUs from the plurality of RUs 112 for serving the UE based on the result of the comparison.

In one non-limiting embodiment, the different downlink signals may comprise Channel State Information Reference Signals (CSI-RSs). In one non-limiting embodiment, each of the one or more groups may comprise distinct RUs. In one non-limiting embodiment, the one or more RUs for serving the UE may change based on one or more factors. In one non-limiting embodiment, each of the plurality of RUs 112 may be configured to serve the same cell.

Referring now to FIG. 14, a flowchart is described illustrating an exemplary UE localization method 1400, according to an embodiment of the present disclosure. The method 1400 is merely provided for exemplary purposes, and embodiments are intended to include or otherwise cover any UE localization methods or procedures.

The method 1400 may include, at block 1402, partitioning available downlink bandwidth into a plurality of sub-bands. For example, the system 102 may be configured to partition the available downlink bandwidth into the plurality of sub-bands.

At block 1404, the method 1400 may include grouping the plurality of RUs 112 into one or more groups. For example, the system 102 may be configured to group the plurality of RUs 112 into one or more groups. Each group may comprise at least one RU and a number of the at least one RU in each group may be less than or equal to a number of the plurality of sub-bands.

At block 1406, the method 1400 may include for each group: configuring each RU of the group to transmit a same downlink signal to a UE in a unique sub-band of the plurality of sub-bands. For example, the system 102 may be configured to configure each RU of the group to transmit the same downlink signal to the UE in the unique sub-band of the plurality of sub-bands. All RUs of the group may transmit the same downlink signal at a particular time instance. Further, the transmissions of the same downlink signal for one group may be repeated for another group at a time instance which is distinct from the particular time instance.

At block 1408, the method 1400 may include for each group: receiving a measurement report comprising sub-band level signal strength measurements of the downlink signal transmissions from the at least one RU of the group after the particular time instance. For example, the system 102 may be configured to receive the measurement report comprising the sub-band level signal strength measurements of the downlink signal transmissions from the at least one RU of the group after the particular time instance.

At block 1410, the method 1400 may include selecting one or more RUs from the plurality of RUs 112 for serving the UE based on the received measurement reports. For example, the system 102 may be configured to select one or more RUs from the plurality of RUs 112 for serving the UE based on the received measurement reports.

In one non-limiting embodiment of the present disclosure, the method 1400 may further comprise comparing the sub-band level signal strength measurements of the downlink signal transmissions with a predefined threshold value and selecting the one or more RUs from the plurality of RUs 112 for serving the UE based on a result of the comparison. For example, the system 102 may be configured to compare the sub-band signal strength measurements of the downlink signal transmissions with the predefined threshold value and select the one or more RUs from the plurality of RUs 112 for serving the UE based on the result of the comparison.

In one non-limiting embodiment, the different downlink signals may comprise Channel State Information Reference Signals (CSI-RSs). In one non-limiting embodiment, each of the one or more groups may comprise distinct RUs. In one non-limiting embodiment, the one or more RUs for serving the UE may change based on one or more factors. In one non-limiting embodiment, each of the plurality of RUs 112 may be configured to serve the same cell.

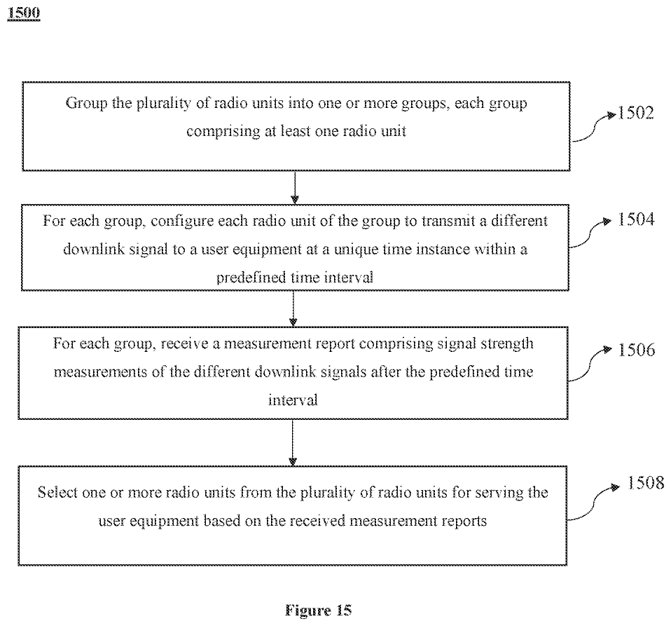

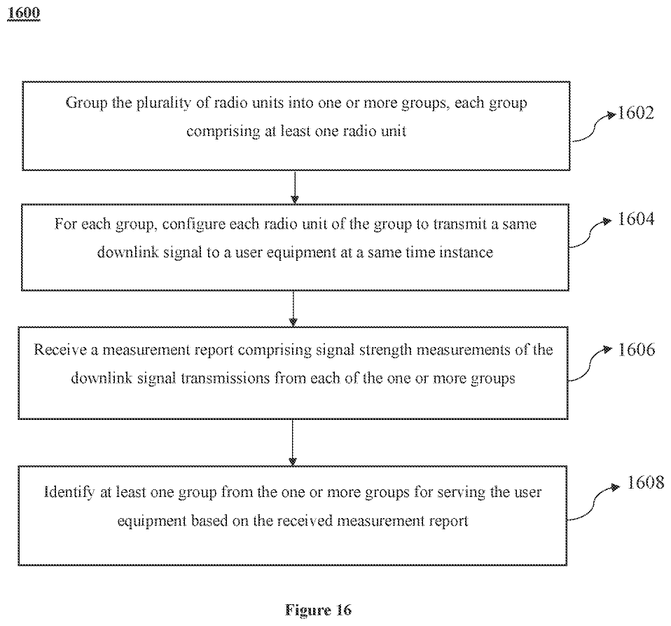

Referring now to FIG. 15, a flowchart is described illustrating an exemplary UE localization method 1500, according to an embodiment of the present disclosure. The method 1500 is merely provided for exemplary purposes, and embodiments are intended to include or otherwise cover any UE localization methods or procedures.

The method 1500 may include, at block 1502, grouping a plurality of RUs 112 into one or more groups, each group comprising at least one RU. For example, the system 102 may be configured to group the plurality of RUs 112 into one or more groups.

At block 1504, the method 1500 may include for each group, configuring each RU of the group to transmit a different downlink signal to a UE at a unique time instance within a predefined time interval. For example, the system 102 may be configured to configure each RU of the group to transmit the different downlink signal to the UE at the unique time instance within the predefined time interval. The transmissions of the different downlink signals for one group may be repeated in a same sequential manner for another group at time instances distinct from the unique time instances. A time duration between two consecutive downlink signal transmissions within each of the one or more groups may be the same.

At block 1506, the method 1500 may include for each group, receiving a measurement report comprising signal strength measurements of the different downlink signals after the predefined time interval. For example, the system 102 may be configured to receive the measurement report comprising signal strength measurements of the different downlink signals after the predefined time interval.

At block 1508, the method 1500 may include selecting one or more RUs from the plurality of RUs 112 for serving the UE based on the received measurement reports. For example, the system 102 may be configured to select one or more RUs from the plurality of RUs 112 for serving the UE based on the received measurement reports.

In one non-limiting embodiment of the present disclosure, the method 1500 may further comprise comparing the signal strength measurements of the different downlink signals with a predefined threshold value and selecting the one or more RUs from the plurality of RUs 112 for serving the UE based on a result of the comparison. For example, the system 102 may be configured to compare the signal strength measurements of the different downlink signals with the predefined threshold value and select the one or more RUs from the plurality of RUs 112 for serving the UE based on the result of the comparison.

In one non-limiting embodiment, the different downlink signals may comprise Synchronization signal blocks (SSBs) which are transmitted periodically in the form of a SSB burst. In one non-limiting embodiment, a time duration between two consecutive downlink signal transmissions across the one or more groups may be different from the time duration between two consecutive downlink signal transmissions within a group. In one non-limiting embodiment, each of the one or more groups may comprise distinct RUs. In one non-limiting embodiment, the one or more RUs for serving the UE may change based on one or more factors. In one non-limiting embodiment, each of the plurality of RUs 112 may be configured to serve the same cell.

Referring now to FIG. 16, a flowchart is described illustrating an exemplary UE localization method 1600, according to an embodiment of the present disclosure. The method 1600 is merely provided for exemplary purposes, and embodiments are intended to include or otherwise cover any UE localization methods or procedures.

The method 1600 may include, at block 1602, grouping a plurality of RUs 112 into one or more groups, each group comprising at least one RU. For example, the system 102 may be configured to group the plurality of RUs 112 into one or more groups.

At block 1604, the method 1600 may include for each group, configuring each RU of the group to transmit a same downlink signal to a UE at a same time instance. For example, the system 102 may be configured to configure each RU of the group to transmit the same downlink signal to the UE at the same time instance. A downlink signal transmitted from one group of RUs at a time instance may be different from a downlink signal transmitted from another group of RUs at a different time instance.

At block 1606, the method 1600 may include receiving a measurement report comprising signal strength measurements of the downlink signal transmissions from each of the one or more groups. For example, the system 102 may be configured to receive the measurement report comprising signal strength measurements of the downlink signal transmissions from each of the one or more groups.

At block 1608, the method 1600 may include identifying at least one group from the one or more groups for serving the UE based on the received measurement report. For example, the system 102 may be configured to identify at least one group from the one or more groups for serving the UE based on the received measurement report.

In one non-limiting embodiment of the present disclosure, the different downlink signals may comprise SSBs and the method 1600 may further comprise configuring RUs of the at least one identified group to transmit one or more CSI-RSs to the UE and receiving one or more signal strength measurements related to the one or more CSI-RS transmissions. The method 1600 may further include selecting at least one RU from the RUs of the at least one identified group for serving the UE, based on the received one or more signal strength measurements.

In one non-limiting embodiment of the present disclosure, the different downlink signals may comprise SSBs and the method 1600 may further comprise configuring the plurality of RUs 112 to transmit one or more CSI-RSs to the UE and receiving one or more signal strength measurements related to the one or more CSI-RS transmissions. The method 1600 may further include selecting at least one RU from the plurality of RUs 112 for serving the UE, based on the received one or more signal strength measurements.

In one non-limiting embodiment of the present disclosure, the method 1600 may further comprise comparing the signal strength measurements of the downlink signal transmissions with a predefined threshold value and selecting the one or more RUs from the plurality of RUs 112 for serving the UE based on a result of the comparison. For example, the system 102 may be configured to compare the signal strength measurements of the downlink signal transmissions with the predefined threshold value and select the one or more RUs from the plurality of RUs 112 for serving the UE based on the result of the comparison.

In one non-limiting embodiment of the present disclosure, each of the one or more groups may comprise distinct RUs. In one non-limiting embodiment, each of the plurality of RUs 112 may be configured to serve the same cell.

The above methods 1200, 1300, 1400, 1500, and 1600 may be described in the general context of computer executable instructions. Generally, computer executable instructions can include routines, programs, objects, components, data structures, procedures, modules, and functions, which perform specific functions or implement specific abstract data types.

The various blocks of the methods 1200, 1300, 1400, 1500, and 1600 shown in FIGS. 12-16 have been arranged in a generally sequential manner for ease of explanation. However, it is to be understood that this arrangement is merely exemplary, and it should be recognized that the processing associated with methods 1200, 1300, 1400, 1500, and 1600 (and the blocks shown in FIGS. 12-16) may occur in a different order (for example, where at least some of the processing associated with the blocks is performed in parallel and/or in an event-driven manner). Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s). Generally, where there are operations illustrated in Figures, those operations may have corresponding counterpart means-plus-function components.

It may be noted here that the subject matter of some or all embodiments described with reference to FIGS. 1-10 may be relevant for the methods and the same is not repeated for the sake of brevity.

In a non-limiting embodiment of the present disclosure, one or more non-transitory computer-readable media may be utilized for implementing the embodiments consistent with the present disclosure. A computer-readable media refers to any type of physical memory (such as the memory 1110) on which information or data readable by a processor may be stored. Thus, a computer-readable media may store one or more instructions for execution by the at least one processor 1108, including instructions for causing the at least one processor 1108 to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Thus, certain non-limiting embodiments may comprise a computer program product for performing the operations presented herein. For example, such a computer program product may comprise a computer readable media having instructions stored (and/or encoded) thereon, the instructions being executable by one or more processors to perform the operations described herein. For certain non-limiting embodiments, the computer program product may include packaging material.

The terms “connected”, “coupled”, and “communicatively coupled” and related terms may refer to direct or indirect connections.

The phrase “based on” does not mean “based only on,” unless expressly specified otherwise. In other words, the phrase “based on” describes both “based only on” and “based at least on”. Additionally, the term “and/or” means “and” or “or”. For example, “A and/or B” can mean “A”, “B”, or “A and B”. Additionally, “A, B, and/or C” can mean “A alone,” “B alone,” “C alone,” “A and B,” “A and C,” “B and C” or “A, B, and C.”

As used herein, a phrase referring to “at least one” or “one or more” of a list of items refers to any combination of those items, including single members. As an example, “at least one of: A, B, or C” is intended to cover: A, B, C, A-B, A-C, B-C, and A-B-C. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the disclosed methods and systems.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the appended claims.

### Example Embodiments

Example 1 includes a method performed using a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, the method comprising: grouping the plurality of radio units into one or more groups, each group comprising at least one radio unit; for each group: configuring each radio unit of the group to transmit a different downlink signal to a user equipment at a unique time instance within a predefined time interval, wherein the transmissions of the different downlink signals for one group are repeated in a same sequential manner for another group at time instances distinct from the unique time instances, and wherein a time duration between two consecutive downlink signal transmissions within a group and across the one or more groups is same; and receiving a measurement report comprising signal strength measurements of the different downlink signals at the end of the predefined time interval; and selecting one or more radio units from the plurality of radio units for serving the user equipment based on the received measurement reports.

Example 2 includes the method of Example 1, further comprising: comparing the signal strength measurements of the downlink signals with a predefined threshold value; and selecting the one or more radio units from the plurality of radio units for serving the user equipment based on a result of the comparison.

Example 3 includes the method of any of Examples 1-2, wherein configuring each radio unit of the group to transmit a different downlink signal comprises configuring each radio unit of the group to transmit a wideband downlink signal to the user equipment.

Example 4 includes the method of any of Examples 1-3, wherein the different downlink signals comprise Channel State Information Reference Signals (CSI-RSs).

Example 5 includes the method of any of Examples 1-4, wherein each of the one or more groups comprises distinct radio units.

Example 6 includes the method of any of Examples 1-5, wherein the one or more radio units for serving the user equipment change based on one or more factors.

Example 7 includes the method of any of Examples 1-6, wherein each of the plurality of radio units is configured to serve a same cell.

Example 8 includes the method of any of Examples 1-7, wherein the at least one baseband unit comprises at least one distributed unit.

Example 9 includes a method performed using a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, the method comprising: (a) partitioning available downlink bandwidth into a plurality of sub-bands; (b) grouping the plurality of radio units into one or more groups, wherein each group comprises at least one radio unit, and wherein a number of the at least one radio unit in each group is less than or equal to a number of the plurality of sub-bands; (c) at a first-time instance, performing the following for each group: configuring each radio unit of the group to transmit a same downlink signal to a user equipment in a unique sub-band of the plurality of sub-bands, wherein a downlink signal transmitted from at least one radio unit of one group is different from a downlink signal transmitted from at least one radio unit of another group; (d) receiving a measurement report comprising sub-band level signal strength measurements of the downlink signal transmissions from the plurality of radio units after the first-time instance; and (e) selecting one or more radio units from the plurality of radio units for serving the user equipment based on the received measurement report.

Example 10 includes the method of Example 9, further comprising: comparing the sub-band level signal strength measurements of the downlink signal transmissions with a predefined threshold value; and selecting the one or more radio units from the plurality of radio units for serving the user equipment based on a result of the comparison.

Example 11 includes the method of any of Examples 9-10, further comprising: repeating steps (c)-(d) at subsequent time instances, wherein for each subsequent time instance, each of the at least one radio unit of the group transmits the downlink signal to the user equipment in a sub-band which is different from the unique sub-bands previously used by the radio unit, and wherein a number of different time instances at which the downlink signals are transmitted is equal to the number of the plurality of sub-bands.

Example 12 includes the method of Example 11, further comprising: determining an average signal strength for each radio unit based on the sub-band level signal strength measurements of each radio unit across the plurality of sub-bands; and selecting one or more radio units from the plurality of radio units for serving the user equipment based on the average signal strengths.

Example 13 includes the method of Example 12, further comprising: comparing the average signal strengths for each radio unit with a predefined threshold value; and selecting the one or more radio units from the plurality of radio units for serving the user equipment based on a result of the comparison.

Example 14 includes the method of any of Examples 9-13, wherein the different downlink signals comprise Channel State Information Reference Signals (CSI-RSs).

Example 15 includes the method of any of Examples 9-14, wherein each of the one or more groups comprises distinct radio units.

Example 16 includes the method of any of Examples 9-15, wherein the one or more radio units for serving the user equipment change based on one or more factors.

Example 17 includes the method of any of Examples 9-16, wherein each of the plurality of radio units is configured to serve a same cell.

Example 18 includes the method of any of Examples 9-17, wherein the at least one baseband unit comprises at least one distributed unit.

Example 19 includes a method performed using a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, the method comprising: partitioning available downlink bandwidth into a plurality of sub-bands; grouping the plurality of radio units into at least one group, wherein each group comprises at least one radio unit, and wherein a number of the at least one radio unit in each group is less than or equal to a number of the plurality of sub-bands; for each group: configuring each radio unit of the group to transmit a same downlink signal to a user equipment in a unique sub-band of the plurality of sub-bands, wherein all radio units of the group transmit the same downlink signal at a particular time instance, and wherein the transmissions of the same downlink signal for one group are repeated for another group at a time instance which is distinct from the particular time instance; and receiving a measurement report comprising sub-band level signal strength measurements of the downlink signal transmissions from the at least one radio unit of the group after the particular time instance; and selecting one or more radio units from the plurality of radio units for serving the user equipment based on the received measurement reports.

Example 20 includes the method of Example 19, further comprising: comparing the sub-band level signal strength measurements of the downlink signal transmissions with a predefined threshold value; and selecting the one or more radio units from the plurality of radio units for serving the user equipment based on a result of the comparison.

Example 21 includes the method of any of Examples 19-20, wherein the different downlink signals comprise Channel State Information Reference Signals (CSI-RSs).

Example 22 includes the method of any of Examples 19-21, wherein each of the one or more groups comprises distinct radio units.

Example 23 includes the method of any of Examples 19-22, wherein the one or more radio units for serving the user equipment change based on one or more factors.

Example 24 includes the method of any of Examples 19-23, wherein each of the plurality of radio units is configured to serve a same cell.

Example 25 includes the method of any of Examples 19-24, wherein the at least one baseband unit comprises at least one distributed unit.

Example 26 includes a method performed using a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, the method comprising: grouping the plurality of radio units into one or more groups, each group comprising at least one radio unit; for each group: configuring each radio unit of the group to transmit a different downlink signal to a user equipment at a unique time instance within a predefined time interval, wherein the transmissions of the different downlink signals for one group are repeated in a same sequential manner for another group at time instances distinct from the unique time instances, and wherein a time duration between two consecutive downlink signal transmissions within each of the one or more groups is same; and receiving a measurement report comprising signal strength measurements of the different downlink signals after the predefined time interval; and selecting one or more radio units from the plurality of radio units for serving the user equipment based on the received measurement reports.

Example 27 includes the method of Example 26, further comprising: comparing the signal strength measurements of the different downlink signals with a predefined threshold value; and selecting the one or more radio units from the plurality of radio units for serving the user equipment based on a result of the comparison.

Example 28 includes the method of any of Examples 26-27, wherein the different downlink signals comprise Synchronization signal blocks (SSBs) which are transmitted periodically in the form of a SSB burst.

Example 29 includes the method of any of Examples 26-28, wherein a time duration between two consecutive downlink signal transmissions across the one or more groups is different from the time duration between two consecutive downlink signal transmissions within a group.

Example 30 includes the method of any of Examples 26-29, wherein each of the one or more groups comprises distinct radio units.

Example 31 includes the method of any of Examples 26-30, wherein the one or more radio units for serving the user equipment change based on one or more factors.

Example 32 includes the method of any of Examples 26-31, wherein each of the plurality of radio units is configured to serve a same cell.

Example 33 includes the method of any of Examples 26-32, wherein the at least one baseband unit comprises at least one distributed unit.

Example 34 includes a method performed using a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, the method comprising: grouping the plurality of radio units into at least one group, wherein each group comprises at least one radio unit; for each group: configuring each radio unit of the group to transmit a same downlink signal to a user equipment at a same time instance, wherein a downlink signal transmitted from one group of radio units at a time instance is different from a downlink signal transmitted from another group of radio units at a different time instance; receiving a measurement report comprising signal strength measurements of the downlink signal transmissions from each of the one or more groups; and identifying at least one group from the one or more groups for serving the user equipment based on the received measurement report.

Example 35 includes the method of Example 34, wherein the different downlink signals comprise Synchronization signal blocks (SSBs), the method further comprising: configuring radio units of the at least one identified group to transmit one or more Channel State Information Reference Signals (CSI-RSs) to the user equipment; receiving one or more signal strength measurements related to the one or more CSI-RS transmissions; and selecting at least one radio unit from the radio units of the at least one identified group for serving the user equipment, based on the received one or more signal strength measurements.

Example 36 includes the method of any of Examples 34-35, wherein the different downlink signals comprise Synchronization signal blocks (SSBs), the method further comprising: configuring the plurality of radio units to transmit one or more Channel State Information Reference Signals (CSI-RSs) to the user equipment; receiving one or more signal strength measurements related to the one or more CSI-RS transmissions; and selecting at least one radio unit from the plurality of radio units for serving the user equipment, based on the received one or more signal strength measurements.

Example 37 includes the method of any of Examples 34-36, further comprising: comparing the signal strength measurements of the downlink signal transmissions with a predefined threshold value; and identifying the at least one group from the one or more groups for serving the user equipment based on a result of the comparison.

Example 38 includes the method of any of Examples 34-37, wherein each of the one or more groups comprises distinct radio units.

Example 39 includes the method of any of Examples 34-38, wherein each of the plurality of radio units is configured to serve a same cell.

Example 40 includes the method of any of Examples 34-39, wherein the at least one baseband unit comprises at least one distributed unit.

Example 41 includes a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, wherein the system is configured to: group the plurality of radio units into one or more groups, each group comprising at least one radio unit; for each group: configure each radio unit of the group to transmit a different downlink signal to a user equipment at a unique time instance within a predefined time interval, wherein the transmissions of the different downlink signals for one group are repeated in a same sequential manner for another group at time instances distinct from the unique time instances, and wherein a time duration between two consecutive downlink signal transmissions within a group and across the one or more groups is same; and receive a measurement report comprising signal strength measurements of the different downlink signals at the end of the predefined time interval; and select one or more radio units from the plurality of radio units for serving the user equipment based on the received measurement reports.

Example 42 includes the system of Example 41, further configured to: compare the signal strength measurements of the downlink signals with a predefined threshold value; and select the one or more radio units from the plurality of radio units for serving the user equipment based on a result of the comparison.

Example 43 includes the system of any of Examples 41-42, wherein to configure each radio unit of the group to transmit a different downlink signal, the system is configured to: configure each radio unit of the group to transmit a wideband downlink signal to the user equipment.

Example 44 includes the system of any of Examples 41-43, wherein the different downlink signals comprise Channel State Information Reference Signals (CSI-RSs).

Example 45 includes the system of any of Examples 41-44, wherein each of the one or more groups comprises distinct radio units.

Example 46 includes the system of any of Examples 41-45, wherein the one or more radio units for serving the user equipment change based on one or more factors.

Example 47 includes the system of any of Examples 41-46, wherein each of the plurality of radio units is configured to serve a same cell.

Example 48 includes the system of any of Examples 41-47, wherein the at least one baseband unit comprises at least one distributed unit.

Example 49 includes a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, wherein the system is configured to: (a) partition available downlink bandwidth into a plurality of sub-bands; (b) group the plurality of radio units into one or more groups, wherein each group comprises at least one radio unit, and wherein a number of the at least one radio unit in each group is less than or equal to a number of the plurality of sub-bands; (c) at a first-time instance, perform the following for each group: configuring each radio unit of the group to transmit a same downlink signal to a user equipment in a unique sub-band of the plurality of sub-bands, wherein a downlink signal transmitted from at least one radio unit of one group is different from a downlink signal transmitted from at least one radio unit of another group; (d) receive a measurement report comprising sub-band level signal strength measurements of the downlink signal transmissions from the plurality of radio units after the first-time instance; and (e) select one or more radio units from the plurality of radio units for serving the user equipment based on the received measurement report.

Example 50 includes the system of Example 49, further configured to: compare the sub-band level signal strength measurements of the downlink signal transmissions with a predefined threshold value; and select the one or more radio units from the plurality of radio units for serving the user equipment based on a result of the comparison.

Example 51 includes the system of any of Examples 49-50, further configured to: repeat steps (c)-(d) at subsequent time instances, wherein for each subsequent time instance, each of the at least one radio unit of the group transmits the downlink signal to the user equipment in a sub-band which is different from the unique sub-bands previously used by the radio unit, and wherein a number of different time instances at which the downlink signals are transmitted is equal to the number of the plurality of sub-bands.

Example 52 includes the system of Example 51, further configured to: determine an average signal strength for each radio unit based on the sub-band level signal strength measurements of each radio unit across the plurality of sub-bands; and select one or more radio units from the plurality of radio units for serving the user equipment based on the average signal strengths.

Example 53 includes the system of Example 52, further configured to: compare the average signal strengths for each radio unit with a predefined threshold value; and select the one or more radio units from the plurality of radio units for serving the user equipment based on a result of the comparison.

Example 54 includes the system of any of Examples 49-53, wherein the different downlink signals comprise Channel State Information Reference Signals (CSI-RSs).

Example 55 includes the system of any of Examples 49-54, wherein each of the one or more groups comprises distinct radio units.

Example 56 includes the system of any of Examples 49-55, wherein the one or more radio units for serving the user equipment change based on one or more factors.

Example 57 includes the system of any of Examples 49-56, wherein each of the plurality of radio units is configured to serve a same cell.

Example 58 includes the system of any of Examples 49-57, wherein the at least one baseband unit comprises at least one distributed unit.

Example 59 includes a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, wherein the system is configured to: partition available downlink bandwidth into a plurality of sub-bands; group the plurality of radio units into at least one group, wherein each group comprises at least one radio unit, and wherein a number of the at least one radio unit in each group is less than or equal to a number of the plurality of sub-bands; for each group: configure each radio unit of the group to transmit a same downlink signal to a user equipment in a unique sub-band of the plurality of sub-bands, wherein all radio units of the group transmit the same downlink signal at a particular time instance, and wherein the transmissions of the same downlink signal for one group are repeated for another group at a time instance which is distinct from the particular time instance; and receive a measurement report comprising sub-band level signal strength measurements of the downlink signal transmissions from the at least one radio unit of the group after the particular time instance; and select one or more radio units from the plurality of radio units for serving the user equipment based on the received measurement reports.

Example 60 includes the system of Example 59, further configured to: compare the sub-band level signal strength measurements of the downlink signal transmissions with a predefined threshold value; and select the one or more radio units from the plurality of radio units for serving the user equipment based on a result of the comparison.

Example 61 includes the system of any of Examples 59-60, wherein the different downlink signals comprise Channel State Information Reference Signals (CSI-RSs).

Example 62 includes the system of any of Examples 59-61, wherein each of the one or more groups comprises distinct radio units.

Example 63 includes the system of any of Examples 59-62, wherein the one or more radio units for serving the user equipment change based on one or more factors.

Example 64 includes the system of any of Examples 59-63, wherein each of the plurality of radio units is configured to serve a same cell.

Example 65 includes the system of any of Examples 59-64, wherein the at least one baseband unit comprises at least one distributed unit.

Example 66 includes a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, wherein the system is configured to group the plurality of radio units into one or more groups, each group comprising at least one radio unit; for each group: configure each radio unit of the group to transmit a different downlink signal to a user equipment at a unique time instance within a predefined time interval, wherein the transmissions of the different downlink signals for one group are repeated in a same sequential manner for another group at time instances distinct from the unique time instances, and wherein a time duration between two consecutive downlink signal transmissions within each of the one or more groups is same; and receive a measurement report comprising signal strength measurements of the different downlink signals after the predefined time interval; and select one or more radio units from the plurality of radio units for serving the user equipment based on the received measurement reports.

Example 67 includes the system of Example 66, further configured to: compare the signal strength measurements of the different downlink signals with a predefined threshold value; and select the one or more radio units from the plurality of radio units for serving the user equipment based on a result of the comparison.

Example 68 includes the system of any of Examples 66-67, wherein the different downlink signals comprise Synchronization signal blocks (SSBs) which are transmitted periodically in the form of a SSB burst.

Example 69 includes the system of any of Examples 66-68, wherein a time duration between two consecutive downlink signal transmissions across the one or more groups is different from the time duration between two consecutive downlink signal transmissions within a group.

Example 70 includes the system of any of Examples 66-69, wherein each of the one or more groups comprises distinct radio units.

Example 71 includes the system of any of Examples 66-70, wherein the one or more radio units for serving the user equipment change based on one or more factors.

Example 72 includes the system of any of Examples 66-71, wherein each of the plurality of radio units is configured to serve a same cell.

Example 73 includes the system of any of Examples 66-72, wherein the at least one baseband unit comprises at least one distributed unit.

Example 74 includes a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, wherein the system is configured to: group the plurality of radio units into at least one group, wherein each group comprises at least one radio unit; for each group: configure each radio unit of the group to transmit a same downlink signal to a user equipment at a same time instance, wherein a downlink signal transmitted from one group of radio units at a time instance is different from a downlink signal transmitted from another group of radio units at a different time instance; receive a measurement report comprising signal strength measurements of the downlink signal transmissions from each of the one or more groups; and identify at least one group from the one or more groups for serving the user equipment based on the received measurement report.

Example 75 includes the system of Example 74, wherein the different downlink signals comprise Synchronization signal blocks (SSBs), and wherein the system is further configured to: configure radio units of the at least one identified group to transmit one or more Channel State Information Reference Signals (CSI-RSs) to the user equipment; receive one or more signal strength measurements related to the one or more CSI-RS transmissions; and select at least one radio unit from the radio units of the at least one identified group for serving the user equipment, based on the received one or more signal strength measurements.

Example 76 includes the system of any of Examples 74-75, wherein the different downlink signals comprise Synchronization signal blocks (SSBs), and wherein the system is further configured to: configure the plurality of radio units to transmit one or more Channel State Information Reference Signals (CSI-RSs) to the user equipment; receive one or more signal strength measurements related to the one or more CSI-RS transmissions; and select at least one radio unit from the plurality of radio units for serving the user equipment, based on the received one or more signal strength measurements.

Example 77 includes the system of any of Examples 74-76, further configured to: compare the signal strength measurements of the downlink signal transmissions with a predefined threshold value; and identify the at least one group from the one or more groups for serving the user equipment based on a result of the comparison.

Example 78 includes the system of any of Examples 74-77, wherein each of the one or more groups comprises distinct radio units.

Example 79 includes the system of any of Examples 74-78, wherein each of the plurality of radio units is configured to serve a same cell.

Example 80 includes the system of any of Examples 74-79, wherein the at least one baseband unit comprises at least one distributed unit.

What is claimed is:

1. A method performed using a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, the method comprising:
grouping the plurality of radio units into one or more groups, each group comprising at least one radio unit;
for each group:
configuring each radio unit of the group to transmit a different downlink signal to a user equipment at a unique time instance within a predefined time interval, wherein the transmissions of the different downlink signals for one group are repeated in a same sequential manner for another group at time instances distinct from the unique time instances, and wherein a time duration between two consecutive downlink signal transmissions within a group and across the one or more groups is same; and
receiving a measurement report comprising signal strength measurements of the different downlink signals at the end of the predefined time interval; and
selecting one or more radio units from the plurality of radio units for serving the user equipment based on the received measurement reports.

2. The method of claim 1, further comprising:
comparing the signal strength measurements of the downlink signals with a predefined threshold value; and
selecting the one or more radio units from the plurality of radio units for serving the user equipment based on a result of the comparison.

3. The method of claim 1, wherein configuring each radio unit of the group to transmit a different downlink signal comprises configuring each radio unit of the group to transmit a wideband downlink signal to the user equipment.

4. The method of claim 1, wherein the different downlink signals comprise Channel State Information Reference Signals (CSI-RSs).

5. The method of claim 1, wherein each of the plurality of radio units is configured to serve a same cell.

6. A method performed using a system comprising: at least one baseband unit to perform at least some baseband processing; and a plurality of radio units to wirelessly communicate with a plurality of user equipment via a respective set of one or more antennas, wherein the at least one baseband unit and the plurality of radio units are communicatively coupled with each other, the method comprising:
(a) partitioning available downlink bandwidth into a plurality of sub-bands;
(b) grouping the plurality of radio units into one or more groups, wherein each group comprises at least one radio unit, and wherein a number of the at least one radio unit in each group is less than or equal to a number of the plurality of sub-bands;
(c) at a first-time instance, performing the following for each group:
configuring each radio unit of the group to transmit a same downlink signal to a user equipment in a unique sub-band of the plurality of sub-bands, wherein a downlink signal transmitted from at least one radio unit of one group is different from a downlink signal transmitted from at least one radio unit of another group;
(d) receiving a measurement report comprising sub-band level signal strength measurements of the downlink signal transmissions from the plurality of radio units after the first-time instance; and
(e) selecting one or more radio units from the plurality of radio units for serving the user equipment based on the received measurement report.

7. The method of claim 6, further comprising:
comparing the sub-band level signal strength measurements of the downlink signal transmissions with a predefined threshold value; and
selecting the one or more radio units from the plurality of radio units for serving the user equipment based on a result of the comparison.

8. The method of claim 6, further comprising:
repeating steps (c)-(d) at subsequent time instances, wherein for each subsequent time instance, each of the at least one radio unit of the group transmits the downlink signal to the user equipment in a sub-band which is different from the unique sub-bands previously used by the radio unit, and wherein a number of different time instances at which the downlink signals are transmitted is equal to the number of the plurality of sub-bands.

9. The method of claim 8, further comprising:
determining an average signal strength for each radio unit based on the sub-band level signal strength measurements of each radio unit across the plurality of sub-bands; and
selecting one or more radio units from the plurality of radio units for serving the user equipment based on the average signal strengths.

10. The method of claim 9, further comprising:
comparing the average signal strengths for each radio unit with a predefined threshold value; and
selecting the one or more radio units from the plurality of radio units for serving the user equipment based on a result of the comparison.

11. The method of claim 6, wherein the different downlink signals comprise Channel State Information Reference Signals (CSI-RSs).

12. The method of claim 6, wherein each of the one or more groups comprises distinct radio units.

13. The method of claim 6, wherein each of the plurality of radio units is configured to serve a same cell.

14. A system comprising:
at least one baseband unit to perform at least some baseband processing; and
a plurality of radio units to wirelessly communicate with a plurality of user equipment via a respective set of one or more antennas, wherein the at least one baseband unit and the plurality of radio units are communicatively coupled with each other,
wherein the system is configured to:
group the plurality of radio units into one or more groups, each group comprising at least one radio unit;
for each group:
configure each radio unit of the group to transmit a different downlink signal to a user equipment at a unique time instance within a predefined time interval, wherein the transmissions of the different downlink signals for one group are repeated in a same sequential manner for another group at time instances distinct from the unique time instances, and wherein a time duration between two consecutive downlink signal transmissions within a group and across the one or more groups is same; and
receive a measurement report comprising signal strength measurements of the different downlink signals at the end of the predefined time interval; and
select one or more radio units from the plurality of radio units for serving the user equipment based on the received measurement reports.

15. The system of claim 14, further configured to:
compare the signal strength measurements of the downlink signals with a predefined threshold value; and
select the one or more radio units from the plurality of radio units for serving the user equipment based on a result of the comparison.

16. The system of claim 14, wherein to configure each radio unit of the group to transmit a different downlink signal, the system is configured to:
configure each radio unit of the group to transmit a wideband downlink signal to the user equipment.

17. The system of claim 14, wherein the different downlink signals comprise Channel State Information Reference Signals (CSI-RSs).

18. The system of claim 14, wherein each of the one or more groups comprises distinct radio units.

19. The system of claim 14, wherein each of the plurality of radio units is configured to serve a same cell.

20. The system of claim 14, wherein the at least one baseband unit comprises at least one distributed unit.
